(19) United States
(12) Patent Application Publication
(10) Pub. No.: US 2025/0211304 A1
(43) Pub. Date: Jun. 26, 2025

(54) FEEDBACK OF DELAY DIFFERENCES AND FREQUENCY DIFFERENCES AMONG MULTIPLE TRPS

(71) Applicant: Telefonaktiebolaget LM Ericsson (publ), Stockholm (SE)

(72) Inventors: Siva MURUGANATHAN, Stittsville (CA); Shiwei GAO, Nepean (CA); Xinlin ZHANG, Västra Frölunda (SE)

(21) Appl. No.: 18/846,470

(22) PCT Filed: Mar. 14, 2023
(86) PCT No.: PCT/IB2023/052482

§ 371 Date: Sep. 12, 2024

Related U.S. Application Data
(60) Provisional application No. 63/319,683, filed on Mar. 14, 2022.

(51) Int. Cl. H04B 7/06; H04L 5/00; H04W 72/231

(52) U.S. Cl. CPC H04B 7/0626; H04L 5/0051; H04W 72/231

(57) ABSTRACT

A method, network node and wireless device (WD) for feedback of delay and frequency differences among multiple transmission reception points (TRPs) are disclosed. A method in a WD includes receiving from the an indication of a plurality of non-zero power channel state information reference signal, NZP CSI-RS, resource sets and an indication of at least one of a time difference and a frequency difference associated to each of the plurality of resource sets, a resource set having at least one NZP CSI-RS resource and determining, for each resource, a difference between at least one of the reported time difference and frequency difference relative to a respective one of a reference timing and a reference frequency based at least in part on measurements on the resource set. The method also includes transmitting the determined difference for each resource of the plurality of resource sets.

### FIELD

The present disclosure relates to wireless communications, and in particular, to feedback of delay and frequency differences among multiple transmission reception points (TRPs).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

The next generation mobile wireless communication system (5G) or New Radio (NR), will support a diverse set of use cases and a diverse set of deployment scenarios. The deployment scenarios include deployment at both low frequencies (100s of MHz), similar to LTE today, and very high frequencies (mm waves in the tens of GHz).

Similar to LTE, NR will use OFDM (Orthogonal Frequency Division Multiplexing) in the downlink (i.e. from a network node, gNB, eNB, or base station, to a wireless device or WD). In the uplink (i.e. from WD to gNB), both OFDM and discrete Fourier transform (DFT)-spread OFDM (DFT-S-OFDM), also known as single carrier frequency division multiple access (SC-FDMA) in LTE, will be supported. The basic NR physical resource may thus be seen as a time-frequency grid as illustrated in the example of FIG. 1, where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2^{μ}) kHz where μ is a non-negative integer and may be one of {0, 1, 2, 3, 4}. Δf=15 kHz (e.g., μ=0) is the basic (or reference) subcarrier spacing that is also used in LTE. μ is also referred to as the numerology.

In the time domain, downlink and uplink transmissions in NR will be organized into equally-sized subframes of 1 ms each similar to LTE. A subframe is further divided into multiple slots of equal duration. The slot length is dependent on the subcarrier spacing or numerology and is given by ½^{μ} ms. Each slot consists of 14 OFDM symbols for normal Cyclic Prefix (CP).

Data scheduling in NR may be on a slot basis. An example is shown in FIG. 2, with a 14-symbol slot, where the first two symbols contain a physical downlink control channel (PDCCH) and the remaining symbols contain a physical downlink shared channel (PDSCH). For convenience, a subframe is referred to throughout the following sections.

Downlink transmissions may be dynamically scheduled, i.e., in each slot, the network node (gNB) transmits downlink control information (DCI) about which WD data is to be transmitted to and which resource blocks in the current downlink slot the data is transmitted on. This control signaling is typically transmitted in the first one or two OFDM symbols in each slot in NR. The control information is carried on the PDCCH and data is carried on the PDSCH. A WD first detects and decodes PDCCH and if a PDCCH is decoded successfully, it then decodes the corresponding PDSCH based on the decoded control information in the PDCCH.

Uplink data transmission may also be dynamically scheduled using PDCCH. Similar to downlink, a WD first decodes uplink grants in PDCCH and then transmits data over the physical uplink shared channel (PUSCH) based on the decoded control information in the uplink grant such as modulation order, coding rate, uplink resource allocation, and etc.

### Tracking Reference Signals (TRS)

Similar to LTE, a Channel state Information Reference Signal (CSI-RS) was introduced in NR for channel measurement in the downlink. A CSI-RS is transmitted over an antenna port (either a physical or virtual antenna) on certain resource elements (REs) for a WD to measure the downlink channel associated with the antenna port. CSI-RS for this purpose is also referred to as Non-Zero Power (NZP) CSI-RS. The supported number of antenna ports or CSI-RS ports in NR are {1, 2, 4, 8, 12, 16, 24, 32}.

A Tracking Reference Signal (TRS) is a special NZP CSI-RS with one port and is used for time and frequency tracking in the downlink. FIG. 3 shows an example of a TRS resource configuration in a physical resource block (PRB) and 2 slots. A WD may be configured with one or more periodic TRS, or one or more periodic TRS and aperiodic TRS in NR. For a periodic TRS, the TRS has a periodicity and a slot offset. The periodicity may one of 2^{μ}Xₚ slots where Xₚ=10, 20, 40, or 80. A TRS occupies multiple resource blocks (RBs). When a NZP CSI-RS resource set contains “trs-info”, then the NZP CSI-RS resource set is for TRS.

### Quasi Co-Location

Demodulation reference signals (DMRS) are used for coherent demodulation of PDSCHs. A PDSCH may be associated with one or multiple DMRS antenna ports or simply DMRS ports, each associated with a spatial layer or a multi-input-multiple-output (MIMO) layer. Multiple layers may be multiplexed in a same time and frequency resource, where different data are carried in different layers. The DMRS ports used for a PDSCH transmission are indicated in DCI scheduling the PDSCH.

Several signals may be transmitted from different antenna ports. These signals may have the same large-scale properties, for instance in terms of Doppler shift/spread, average delay spread, or average delay, when measured at a WD receiver. These antenna ports are then said to be quasi co-located (QCL). If the WD knows that two antenna ports, a first and second antenna port, are QCL with respect to a certain channel property (e.g., Doppler spread), the WD may obtain the channel property of the first antenna port (e.g., DMRS) from the second antenna port (e.g., TRS). The reference signal (e.g., TRS) associated with the second antenna port is known as the QCL source RS and the reference signal (e.g., DMRS) associated with the first antenna port is known as the QCL target RS. The supported QCL types in NR are:
‘QCL-TypeA’: {Doppler shift, Doppler spread, average delay, delay spread};
‘QCL-TypeB’: {Doppler shift, Doppler spread};
‘QCL-TypeC’: {Doppler shift, average delay}; and
‘QCL-TypeD’: {Spatial Rx parameter}.

QCL relations are specified by transmission configuration indicator (TCI) states. A TCI state contains one or two source RS and the associated QCL types. In case two QCL types are configured, one is QCL type-D. A WD may be configured by radio resource control (RRC) signaling with a list of TCI states. For PDSCH, one or two TCI states from the list may be activated for each of up to 8 TCI codepoints by a medium access control (MAC) control element (CE) command. Up to 8 TCI states may be activated. One of the TCI codepoints is indicated in downlink control information (DCI) scheduling a PDSCH. The WD performs PDSCH reception according to the TCI state(s) indicated in the TCI codepoint.

Table 1 is a summary of possible source RS and target RS in NR. SSB refers synchronization signal and broadcast channel block, CSI-RS (BM) refers to CSI-RS for beam management in FR2.

TABLE 1
Target and source RS supported in NR.

| | QCL source RS | | | |
|---|---|---|---|---|
| | QCL type | QCL type | QCL type | QCL type |
| Target RS | A | B | C | D |

| | | | |
|---|---|---|---|
| CSI-RS | TRS | | TRS |
| (CSI) | TRS | | SSB |
| | TRS | | CSI-RS (BM) |
| | | TRS | |
| DMRS for | TRS | | TRS |
| PDSCH | TRS | | CSI-RS (BM) |
| | CSI-RS for | | CSI-RS for |
| | CQI | | CSI |

### CSI Framework in NR

In NR, a WD may be configured with one or multiple Channel State Information (CSI) report configurations for downlink (DL) CSI feedback by the WD. A CSI report may contain one or more of:
Channel rank indicator (RI);
Antenna precoding matrix indicator (PMI);
Channel quality indicator (CQI);
DL reference signal received power (RSRP) or signal to interference and noise ratio (SINR); and/or
CSI reference signal (CSI-RS) resource indicator (CRI).

Each CSI report configuration is associated with a bandwidth part (BWP) and contains all the necessary information required for a CSI report, including:
a CSI resource configuration for channel measurement;
reporting type, i.e., aperiodic CSI (on PUSCH), periodic CSI (on PUCCH) or semi-persistent CSI (on PUCCH, and DCI activated on PUSCH); and/or
report quantity specifying what to be reported, such as rank indicator (RI), precoder matrix indicator (PMI), channel quality indicator (CQI), reference signal received power (RSRP), etc.

A WD may be configured with one or multiple CSI resource configurations for channel measurement. Each CSI resource configuration for channel measurement may contain one or more non-zero power (NZP) CSI-RS resource sets. For each NZP CSI-RS resource set, it may further contain one or more NZP CSI-RS resources. A NZP CSI-RS resource may be periodic, semi-persistent, or aperiodic.

Periodic CSI starts after it has been configured by RRC and is reported on PUCCH. The associated NZP CSI-RS resource(s) are also periodic.

Aperiodic CSI, is reported on PUSCH and is activated by a CSI request bit field in DCI. The associated NZP CSI-RS resource(s) may be either periodic, semi-persistent, or aperiodic. The linkage between a code point of the CSI request field and a CSI report configuration is via an aperiodic CSI trigger state. A WD is configured by higher layer a list of aperiodic CSI trigger states, where each of the trigger states contains an associated CSI report configuration. The CSI request field is used to indicate one of the aperiodic CSI trigger states and thus, one CSI report configuration.

If there are more than one NZP CSI-RS resource set and/or more than one CSI interference measurement (CSI-IM) resource set associated with a CSI report configuration, only one NZP CSI-RS resource set is selected in the aperiodic CSI trigger state. Thus, each aperiodic CSI report is based on a single NZP CSI-RS resource set.

CQI and PMI may be reported per subband or wideband. In case of wideband CQI or PMI, the CQI or PMI is for the whole bandwidth configured for CSI report. In case of subband QCI or PMI, the CQI or PMI is reported for each subband. The subband size in NR may be from 4 RBs to 32 RBs, depending on the size of the BWP as shown in the table below.

TABLE 5.2.1.4-2
Configurable subband sizes

| Bandwidth part (PRBs) | Subband size (PRBs) |
|---|---|
| 24-72 | 4, 8 |
| 73-144 | 8, 16 |
| 145-275 | 16, 32 |

PDSCH Transmission from Multiple TRPs

In NR 3GPP Technical Release 16 (3GPP Rel-16), non-coherent joint PDSCH transmission from two transmission and reception points (TRPs) was introduced in which a subset of multiple input multiple output (MIMO) layers of a PDCCH to a WD are transmitted from a first TRP and the rest of layers of the PDSCH are transmitted from a second TRP in the same time and frequency resource. Different layers are separated and received at the WD with MIMO capable receiver.

An example is shown in FIG. 4, where a PDSCH with two layers is scheduled with the first layer transmitted from TRP1 and the second layer from TRP2. This is signaled in the corresponding DCI by indicating a TCI codepoint associated with two TCI states. and DMRS ports x and y in two CDM groups, where DMRS port x in the first CDM group is associated with the first TCI state and DMRS port y in the second CDM group is associated with the second TCI state. The first TCI state may contain TRS1 as the QCL source RS and the second TCI state may contain TRS1 as the QCL source RS.

### SFN PDSCH

In NR 3GPP Rel-17, enhanced single frequency network (SFN) based PDSCH was also introduced for more robust PDSCH reception in which a PDSCH is transmitted simultaneously from two TRPs in a same time and frequency resource.

An example is shown in FIG. 5, where an exact same PDSCH together with its DMRS is transmitted from both TRPs. This is indicated to a WD by both a RRC configuration of SFN PDSCH and two TCI states indicated in a DCI scheduling the PDSCH. The first TCI state may contain TRS1 as the QCL source RS and the second TCI state may contain TRS1TRS2 as the QCL source RS. The DMRS is now associated with the two TCI states because the DMRS is transmitted from both TRPs.

In non-coherent joint transmission (NC-JT)-based multi-TRP PDSCH, different layers or data are transmitted from different TRPs, so for each layer it is only transmitted from one TRP. For SFN based multi-TRP PDSCH, the same data are transmitted from different TRPs. The corresponding signals from different TRPs may be combined either constructively or destructively depending on the relative phase between the signals when they reach the WD. To mitigate the issue of possible signal cancellation, cyclic delay diversity (CDD) is typically used in implementations to introduce a frequency dependent phase shift between the signals such that the relative phase between the signals vary over the scheduled bandwidth.

To further enhance multi-TRP PDSCH transmission, coherent joint transmission (CJT) of a PDSCH from multiple TRPs will be studied and supported in NR 3GPP Rel-18, in which signals from multiple TRPs are coherently combined at a WD through proper joint antenna precoding at the multiple TRPs. This is to be achieved by CSI feedback in which the WD measures the channels associated with the multiple TRPs and reports back a joint precoder across the multiple TRPs such that the precoded signals from the multiple TRPs are phase aligned when they reach the WD.

However, there are a number of challenges in supporting CJT. First, propagation delays between different TRPs and a WD may be quite different. These large delay differences would result in a large frequency selective composite channel, i.e., the channel amplitude and phase vary rapidly across frequency. In existing NR CSI feedback, a precoding matrix per subband is reported. The subband size may vary between 2 RBs to 32 RBs as specified in 3GPP Technical Standard (TS) 38.214. FIG. 6 shows phase variation within a subband for different subband sizes with one microsecond (1 us) delay difference between two TRPs. It may be seen that even with a 2 RB subband size, the phase variation exceeds 130 degrees. For constructive combining of two signals, their phase difference should be less than 90 degrees. Therefore, with current subband size and per subband CSI feedback, signals from multiple TRPs cannot be coherently combined with even 1 us delay difference.

Secondly, even though the same nominal transmit frequency may be used at multiple TRPs, due to local oscillator stability, there will be some actual transmit frequency difference between the multiple TRPs. In 3GPP RAN4, the maximum transmit frequency error for a base station is specified in 3GPP TS 38.104 and is shown in FIG. 7. For the most stringent+/−0.05 ppm requirement, there will be some residual frequency errors. These frequency errors mean that the phase of a signal will change over time.

Hence, in multi-TRP CJT transmission, how to mitigate the propagation delay differences and/or transmit frequency differences is an unaddressed problem. The details of what information the WD may feedback to help mitigate propagation delay differences and/or transmit frequency differences is also an unaddressed problem.

### SUMMARY

Some embodiments advantageously provide methods, network nodes and wireless devices (WDs) for feedback of delay and frequency differences among multiple transmission reception points (TRPs).

Some embodiments mitigate the adverse impacts of propagation delay difference and/or transmit frequency difference between different TRPs on the performance of CJT based multi-TRP operation. Using the propagation delay difference and/or transmit frequency difference values reported by the WD, the network may mitigate these adverse effects.

According to one aspect, a network node configured to communicate with a wireless device, WD, is provided. The network node includes processing circuitry configured to configure the WD with an indication of a plurality of non-zero power channel state information reference signal, NZP CSI-RS, resource sets, each NZP CSI-RS resource set having at least one NZP CSI-RS resource. The network node also includes a radio interface in communication with the processing circuitry and configured to receive from the WD a report comprising at least one of a time difference and a frequency difference for each of at least a subset of the plurality of indicated NZP CSI-RS resource sets, the at least one of the time and frequency difference for a NZP CSI-RS resource set being measured based on the NZP CSI-RS resource set with respect to one of: (a) at least one of a reference timing and a reference frequency; and (b) a reference NZP CSI-RS resource set, the reference NZP CSI-RS resource or resource set is one of the plurality of NZP CSI-RS resource sets.

According to this aspect, in some embodiments, each NZP CSI-RS resource set of the plurality of NZP CSI-RS resource sets is a tracking reference signal, TRS, resource set, and wherein information related to a TRS is one of indicated and configured in the NZP CSI-RS resource set. In some embodiments, each NZP CSI-RS resource of the plurality of NZP CSI-RS resources is a tracking reference signal, TRS, resource. In some embodiments, the plurality of NZP CSI-RS resource sets are transmitted from respective ones of a plurality of transmission and reception points, TRPs. In some embodiments, the report further includes an indication of which one of the plurality of NZP CSI-RS resource sets is the reference NZP CSI-RS resource set, and wherein the at least one of a time and frequency difference for the reference NZP CSI-RS resource set is zero and not included in the report. In some embodiments, the reference NZP CSI-RS set is pre-specified or indicated to the WD. In some embodiments, the time difference for a NZP CSI-RS resource set is a difference between a time delay of a signal received on a NZP CSI-RS resource of the NZP CSI-RS set at the WD and a time delay of the signal received on the reference NZP CSI-RS resource at the WD. In some embodiments, the frequency difference for a NZP CSI-RS resource set is a difference between a frequency of a signal received on a NZP CSI-RS resource of the NZP CSI-RS resource set at the WD and a frequency of the signal received on the reference NZP CSI-RS resource at the WD. In some embodiments, the time difference for a NZP CSI-RS resource set is a time delay of the signal received on a NZP CSI-RS resource at the WD with respect to the reference timing. In some embodiments, the frequency difference for a NZP CSI-RS resource set is a difference between a frequency of a signal received on a NZP CSI-RS resource at the WD with respect to the reference frequency. In some embodiments, the report further includes an indication of a number of transmission and reception points, TRPs, each TRP being associated with at least one of a time difference and a frequency difference. In some embodiments, the network node applies at least one of a time and a frequency pre-compensation to at least one of a physical downlink channel and a reference signal at each of the plurality of transmission and reception points, TRPs, based on the received at least one of a time and frequency difference for a corresponding NZP CSI-RS resource.

According to another aspect, a method in a network node configured to communicate with a wireless device, WD, is provided. The method includes: configuring the WD with an indication of a plurality of non-zero power channel state information reference signal, NZP CSI-RS, resource sets, each NZP CSI-RS resource set having at least one NZP CSI-RS resource. The method also includes receiving from the WD a report comprising at least one of a time difference and a frequency difference for each of at least a subset of the plurality of indicated NZP CSI-RS resource sets, the at least one of the time and frequency difference for a NZP CSI-RS resource set being measured based on the NZP CSI-RS resource set with respect to one of: (a) at least one of a reference timing and a reference frequency; and (b) a reference NZP CSI-RS resource set, the reference NZP CSI-RS resource or resource set is one of the plurality of NZP CSI-RS resource sets.

According to this aspect, in some embodiments, each NZP CSI-RS resource set of the plurality of NZP CSI-RS resource sets is a tracking reference signal, TRS, resource set, and wherein information related to a TRS is one of indicated and configured in the NZP CSI-RS resource set. In some embodiments, each NZP CSI-RS resource of the plurality of NZP CSI-RS resources is a tracking reference signal, TRS, resource. In some embodiments, the plurality of NZP CSI-RS resource sets are transmitted from respective ones of a plurality of transmission and reception points, TRPs. In some embodiments, the report further includes an indication of which one of the plurality of NZP CSI-RS resource sets is the reference NZP CSI-RS resource set, and wherein the at least one of a time and frequency difference for the reference NZP CSI-RS resource set is zero and not included in the report. In some embodiments, the reference NZP CSI-RS set is pre-specified or indicated to the WD. In some embodiments, the time difference for a NZP CSI-RS resource set is a difference between a time delay of a signal received on a NZP CSI-RS resource of the NZP CSI-RS set at the WD and a time delay of the signal received on the reference NZP CSI-RS resource at the WD. In some embodiments, the frequency difference for a NZP CSI-RS resource set is a difference between a frequency of a signal received on a NZP CSI-RS resource of the NZP CSI-RS resource set at the WD and a frequency of the signal received on the reference NZP CSI-RS resource at the WD. In some embodiments, the time difference for a NZP CSI-RS resource set is a time delay of the signal received on a NZP CSI-RS resource at the WD with respect to the reference timing. In some embodiments, the frequency difference for a NZP CSI-RS resource set is a difference between a frequency of a signal received on a NZP CSI-RS resource at the WD with respect to the reference frequency. In some embodiments, the report further includes an indication of a number of transmission and reception points, TRPs, each TRP being associated with at least one of a time difference and a frequency difference. In some embodiments, the network node applies at least one of a time and a frequency pre-compensation to at least one of a physical downlink channel and a reference signal at each of the plurality of transmission and reception points, TRPs, based on the received at least one of a time and frequency difference for a corresponding NZP CSI-RS resource.

According to yet another aspect, a method in a wireless device, WD, configured to communicate with a network node is provided. The method includes receiving from the network node an indication of a plurality of non-zero power channel state information reference signal, NZP CSI-RS, resource sets and an indication of at least one of a time difference and a frequency difference associated to each of the plurality of NZP CSI-RS resource sets, an NZP CSI-RS resource set having at least one NZP CSI-RS resource. The method includes determining, for each NZP CSI-RS resource of the plurality of NZP CSI-RS resource sets, a difference between at least one of the reported time difference and frequency difference relative to a respective one of a reference timing and a reference frequency based at least in part on measurements on the NZP CSI-RS resource set. The method also includes transmitting, to the network node, the determined difference for each NZP CSI-RS resource of the plurality of NZP CSI-RS resource sets.

According to this aspect, in some embodiments, each of the plurality of NZP CSI-RS resource sets is a tracking reference signal, TRS, resource set. In some embodiments, the reference timing and reference frequency area downlink timing and a downlink carrier frequency, respectively, acquired by the WD based on a previously received downlink reference signal. In some embodiments, the reference timing and reference frequency are a downlink timing and a downlink carrier frequency, respectively, associated to a reference NZP CSI-RS resource set, wherein the reference NZP CSI-RS resource set is one of the plurality of NZP CSI-RS resource sets. In some embodiments, the reference NZP CSI-RS resource set is indicated explicitly by the network node. In some embodiments, the reference NZP CSI-RS resource or resource set is a first NZP CSI-RS resource or resource set configured in the plurality of NZP CSI-RS resources or resource sets. In some embodiments, the reference NZP CSI-RS resource set is determined and reported by the WD. In some embodiments, the time difference for a NZP CSI-RS resource set is a difference between a time delay of the NZP CSI-RS resource received at the WD and a time delay of the reference NZP CSI-RS resource received at the WD. In some embodiments, the frequency difference for a NZP CSI-RS resource set is a difference between a carrier frequency of a NZP CSI-RS resource of the NZP CSI-RS resource set received at the WD and a carrier frequency of the reference NZP CSI-RS resource received at the WD. In some embodiments, the time difference for a NZP CSI-RS resource set is a time delay of the NZP CSI-RS resource received at the WD with respect to the reference timing. In some embodiments, the frequency difference for a NZP CSI-RS resource set is a difference between a carrier frequency of a NZP CSI-RS resource received at the WD with respect to the reference carrier frequency. In some embodiments, the report further comprises an indication of the reference resource set. In some embodiments, the report is one of periodic, aperiodic, and semi-persistent. In some embodiments, each of the plurality of NZP CSI-RS resource sets is one of periodic, aperiodic, and semi-persistent. In some embodiments, the indication of a plurality of non-zero power channel state information reference signal, NZP CSI-RS, resource sets, and the indication of the at least one of a time difference and a frequency difference is carried in one of a downlink control information, DCI, format, a radio resource control, RRC, message, and a medium access control, MAC, message.

According to another aspect, a wireless device, WD, configured to communicate with a network node is provided. The WD includes: a radio interface configured to receive from the network node an indication of a plurality of non-zero power channel state information reference signal, NZP CSI-RS, resource sets and an indication of at least one of a time difference and a frequency difference associated to each of the plurality of NZP CSI-RS resource sets, an NZP CSI-RS resource set having at least one NZP CSI-RS resource. The method includes processing circuitry in communication with the radio interface and configured to determine, for each NZP CSI-RS resource of the plurality of NZP CSI-RS resource sets, a difference between at least one of the reported time difference and frequency difference relative to a respective one of a reference timing and a reference frequency based at least in part on measurements on the NZP CSI-RS resource set. The radio interface is further configured to transmit, to the network node, the determined difference for each NZP CSI-RS resource of the plurality of NZP CSI-RS resource sets.

According to this aspect, in some embodiments, each of the plurality of NZP CSI-RS resource sets is a tracking reference signal, TRS, resource set. In some embodiments, the reference timing and reference frequency area downlink timing and a downlink carrier frequency, respectively, acquired by the WD based on a previously received downlink reference signal. In some embodiments, the reference timing and reference frequency are a downlink timing and a downlink carrier frequency, respectively, associated to a reference NZP CSI-RS resource set, wherein the reference NZP CSI-RS resource set is one of the plurality of NZP CSI-RS resource sets. In some embodiments, the reference NZP CSI-RS resource set is indicated explicitly by the network node. In some embodiments, the reference NZP CSI-RS resource or resource set is a first NZP CSI-RS resource or resource set configured in the plurality of NZP CSI-RS resources or resource sets. In some embodiments, the reference NZP CSI-RS resource set is determined and reported by the WD. In some embodiments, the time difference for a NZP CSI-RS resource set is a difference between a time delay of the NZP CSI-RS resource received at the WD and a time delay of the reference NZP CSI-RS resource received at the WD. In some embodiments, the frequency difference for a NZP CSI-RS resource set is a difference between a carrier frequency of a NZP CSI-RS resource of the NZP CSI-RS resource set received at the WD and a carrier frequency of the reference NZP CSI-RS resource received at the WD. In some embodiments, the time difference for a NZP CSI-RS resource set is a time delay of the NZP CSI-RS resource received at the WD with respect to the reference timing. In some embodiments, the frequency difference for a NZP CSI-RS resource set is a difference between a carrier frequency of a NZP CSI-RS resource received at the WD with respect to the reference carrier frequency. In some embodiments, the report further comprises an indication of the reference resource set. In some embodiments, the report is one of periodic, aperiodic, and semi-persistent. In some embodiments, each of the plurality of NZP CSI-RS resource sets is one of periodic, aperiodic, and semi-persistent. In some embodiments, the indication of a plurality of non-zero power channel state information reference signal, NZP CSI-RS, resource sets, and the indication of the at least one of a time difference and a frequency difference is carried in one of a downlink control information, DCI, format, a radio resource control, RRC, message, and a medium access control, MAC, message.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example of NR physical resources;

FIG. 2 is an example of an NR time domain structure;

FIG. 3 is an example of resource element allocation;

FIG. 4 is an example of PDCCH repetition;

FIG. 5 is an example of SFN PDCCH;

FIG. 6 is an example of phase variation over a subband;

FIG. 7 is an example of 3GPP minimum requirements on transmit frequency error;

FIG. 8 is a schematic diagram of an example network architecture illustrating a communication system connected via an intermediate network to a host computer according to the principles in the present disclosure;

FIG. 9 is a block diagram of a host computer communicating via a network node with a wireless device over an at least partially wireless connection according to some embodiments of the present disclosure;

FIG. 10 is a flowchart illustrating example methods implemented in a communication system including a host computer, a network node and a wireless device for executing a client application at a wireless device according to some embodiments of the present disclosure;

FIG. 11 is a flowchart illustrating example methods implemented in a communication system including a host computer, a network node and a wireless device for receiving user data at a wireless device according to some embodiments of the present disclosure;

FIG. 12 is a flowchart illustrating example methods implemented in a communication system including a host computer, a network node and a wireless device for receiving user data from the wireless device at a host computer according to some embodiments of the present disclosure;

FIG. 13 is a flowchart illustrating example methods implemented in a communication system including a host computer, a network node and a wireless device for receiving user data at a host computer according to some embodiments of the present disclosure;

FIG. 14 is a flowchart of an example process in a network node for feedback of delay and frequency differences among multiple transmission reception points (TRPs) according to some embodiments of the present disclosure;

FIG. 15 is a flowchart of an example process in a wireless device for feedback of delay and frequency differences among multiple transmission reception points (TRPs) according to some embodiments of the present disclosure;

FIG. 16 is a flowchart of an example process in a network node for feedback of delay and frequency differences among multiple transmission reception points (TRPs) according to some embodiments of the present disclosure;

FIG. 17 is a flowchart of an example process in a wireless device for feedback of delay and frequency differences among multiple transmission reception points (TRPs) according to some embodiments of the present disclosure;

FIG. 18 is an example of signals from two TRPs;

FIG. 19 is one example of a first set of embodiments according to principles set forth herein;

FIG. 20 is an example of delay measurement based on TRS from two TRPs;

FIG. 21 is one example of a second set of embodiments according to principles set forth herein;

FIG. 22 is one example of a third set of embodiments according to principles set forth herein; and

FIG. 23 is an example of frequency measurement based on TRS from two TRPs.

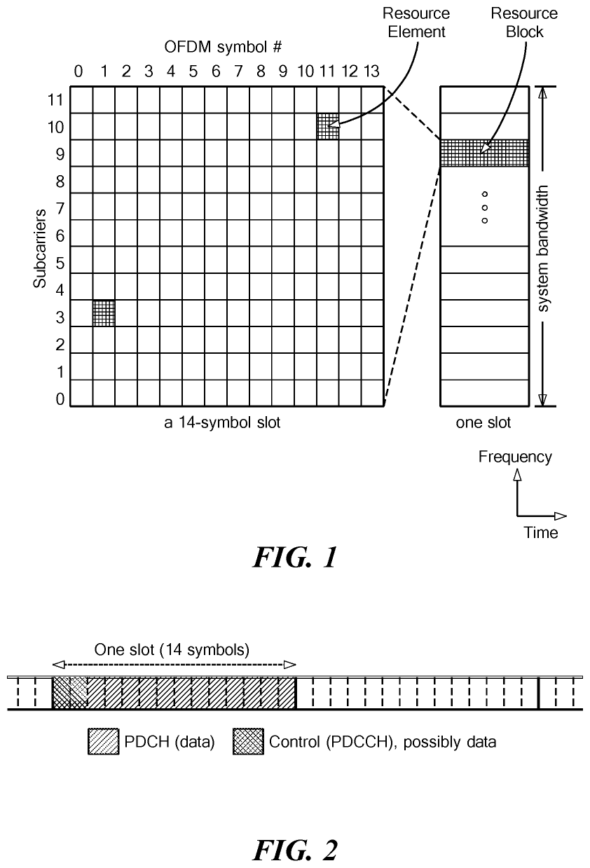

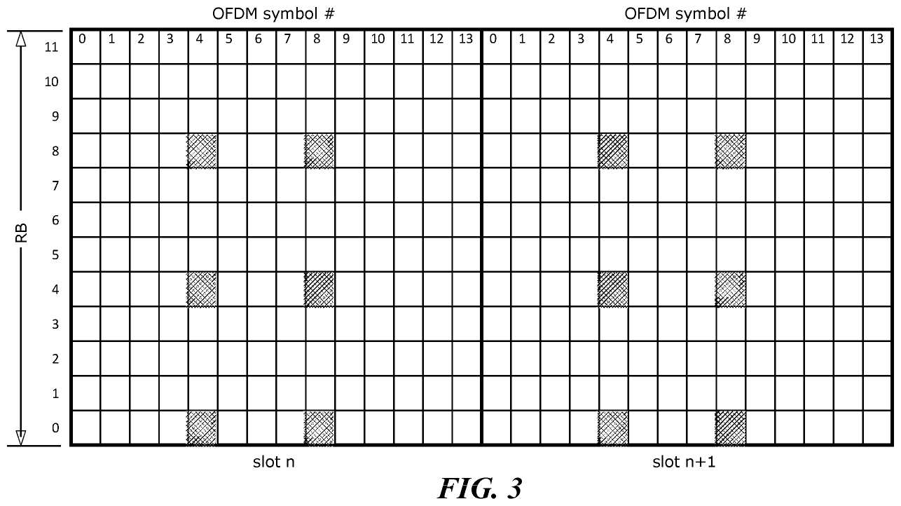

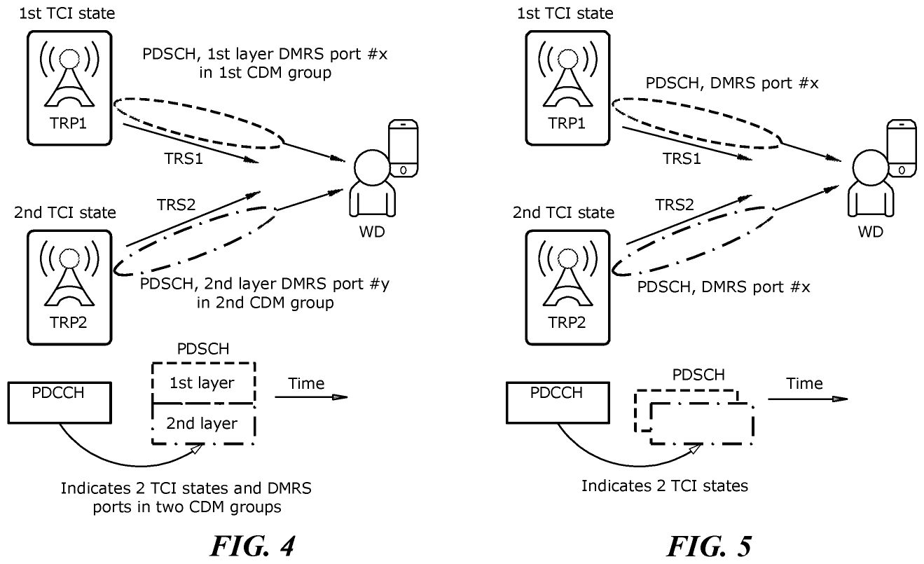

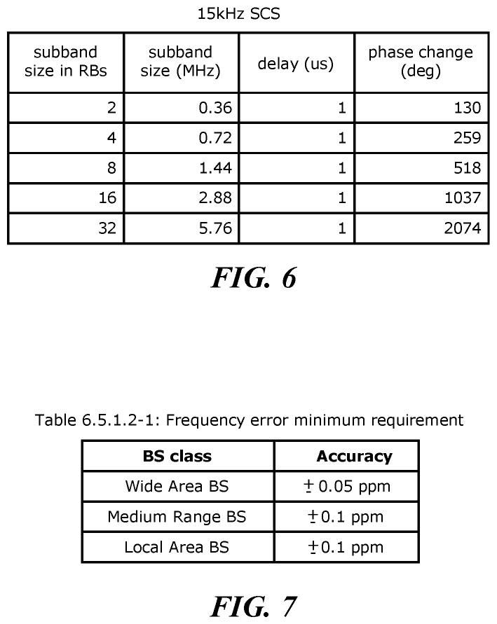

### DETAILED DESCRIPTION

Before describing in detail example embodiments, it is noted that the embodiments reside primarily in combinations of apparatus components and processing steps related to feedback of delay and frequency differences among multiple transmission reception points (TRPs). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node. The term, “network node,” may refer to a transmission reception point (TRP) and a TRP may refer to a network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc. The term, “WD,” may refer to a TRP and a TRP may refer to a WD.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

As used herein, the term “reporting quantity” may include propagation delay, propagation delay difference, transmit frequency and/or transmit frequency difference.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide feedback of delay and frequency differences among multiple transmission reception points (TRPs).

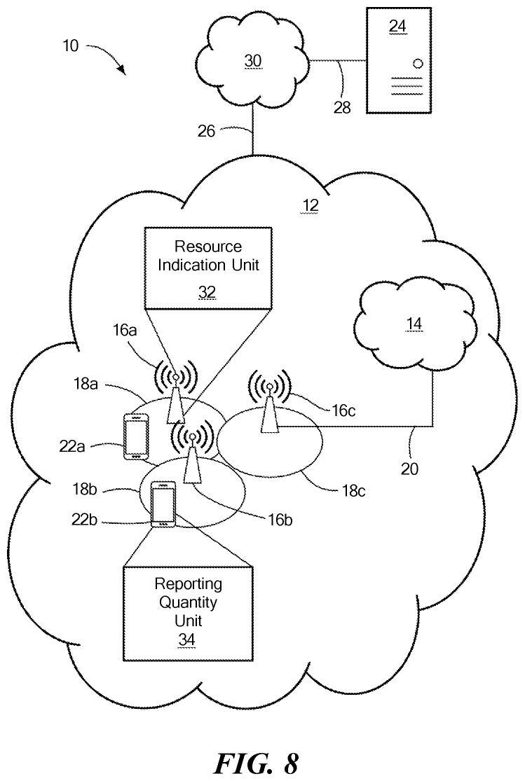

Returning now to the drawing figures, in which like elements are referred to by like reference numerals, there is shown in FIG. 8 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 8 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a resource indication unit 32 which is configured to configure the WD with an indication of a plurality of non-zero power channel state information reference signal, NZP CSI-RS, resources. A wireless device 22 is configured to include a reporting quantity unit 34 which is configured to determine reporting quantity for each NZP CSI-RS resource of at least a subset of the plurality of indicated NZP CSI-RS resources, the reporting quantity being based on measurements on the NZP CSI-RS resource.

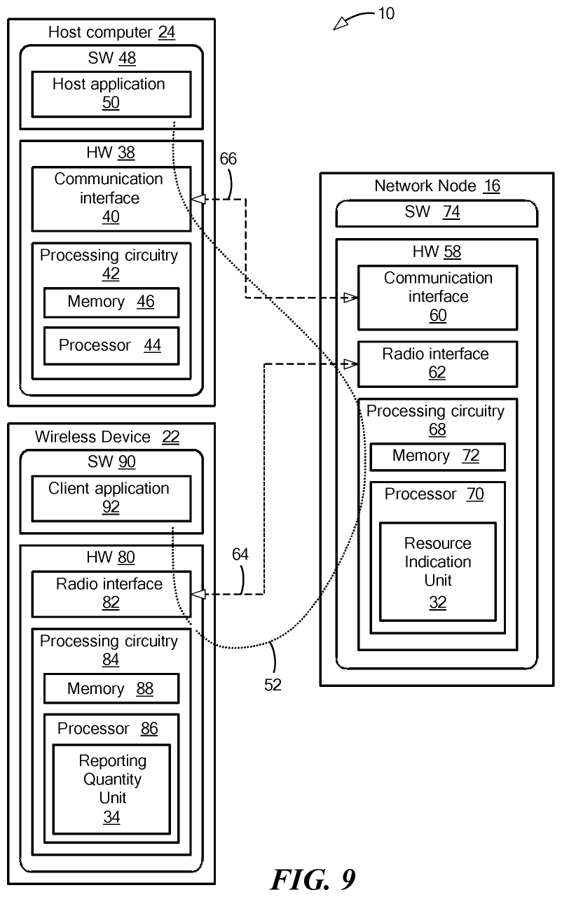

Example implementations, in accordance with an embodiment, of the WD 22, network node 16 and host computer 24 discussed in the preceding paragraphs will now be described with reference to FIG. 9. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include resource indication unit 32 which is configured to configure the WD with an indication of a plurality of non-zero power channel state information reference signal, NZP CSI-RS, resources.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include reporting quantity unit 34 which is configured to determine a reporting quantity for each NZP CSI-RS resource of at least a subset of the plurality of indicated NZP CSI-RS resources, the reporting quantity being based at least in part on measurements on the NZP CSI-RS resource.

In some embodiments, the inner workings of the network node 16, WD 22, and host computer 24 may be as shown in FIG. 9 and independently, the surrounding network topology may be that of FIG. 8.

In FIG. 9, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 8 and 9 show various “units” such as resource indication unit 32, and reporting quantity unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

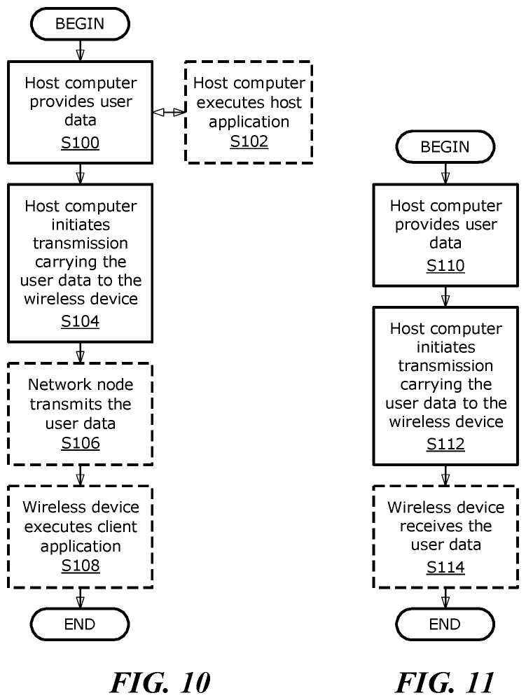

FIG. 10 is a flowchart illustrating an example method implemented in a communication system, such as, for example, the communication system of FIGS. 8 and 9, in accordance with one embodiment. The communication system may include a host computer 24, a network node 16 and a WD 22, which may be those described with reference to FIG. 9. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 11 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

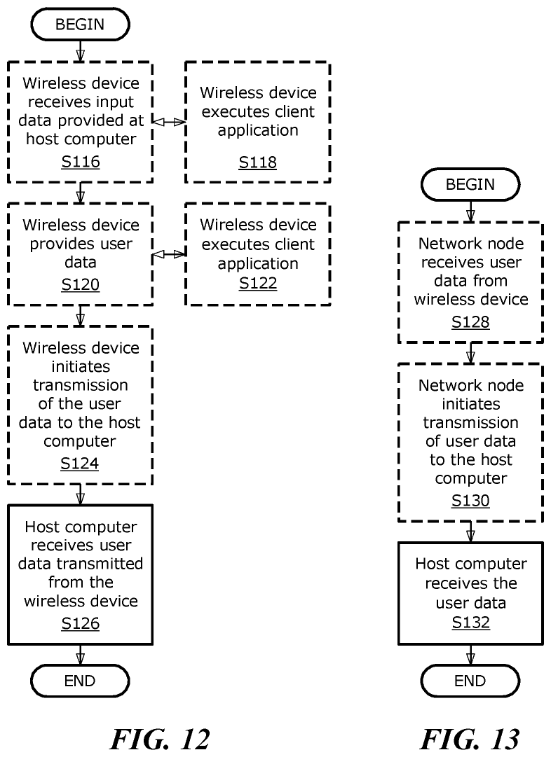

FIG. 12 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 13 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

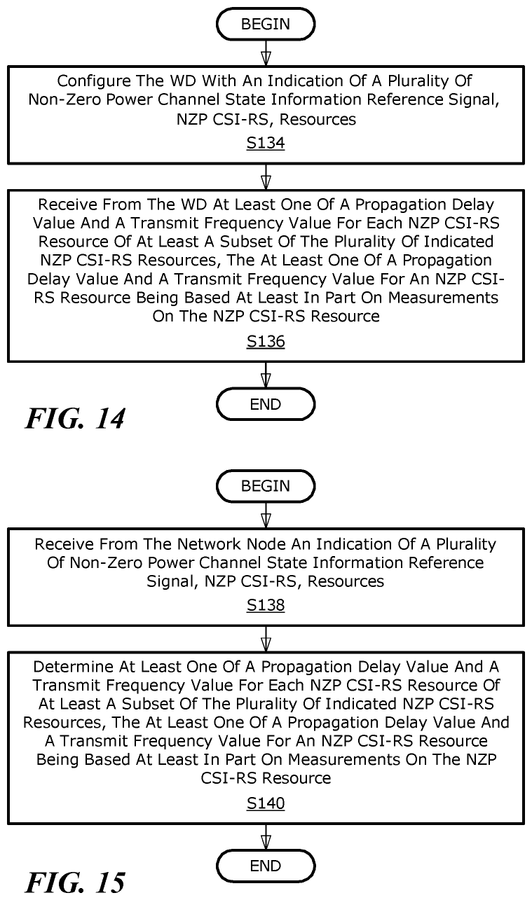

FIG. 14 is a flowchart of an example process in a network node 16 for feedback of delay and frequency differences among multiple transmission reception points (TRPs). One or more blocks described herein may be performed by one or more elements of network node 16 such as by one or more of processing circuitry 68 (including the resource indication unit 32), processor 70, radio interface 62 and/or communication interface 60. Network node 16 such as via processing circuitry 68 and/or processor 70 and/or radio interface 62 and/or communication interface 60 is configured to configure the WD 22 with an indication of a plurality of non-zero power channel state information reference signal, NZP CSI-RS, resources (Block S134). The process also includes receiving from the WD 22 at least one of a propagation delay value and a transmit frequency value for each NZP CSI-RS resource of at least a subset of the plurality of indicated NZP CSI-RS resources, the at least one of a propagation delay value and a transmit frequency value for an NZP CSI-RS resource being based at least in part on measurements on the NZP CSI-RS resource (Block S136).

In some embodiments, the plurality of NZP CSI-RS resources are grouped into NZP CSI-RS resource sets, and the indication indicates a plurality of NZP CSI-RS resource sets. In some embodiments, the indication indicates a subset of NZP CSI-RS resources for which one of propagation delay values and transmit frequency values are to be reported. In some embodiments, the indication indicates one of the plurality of indicated NZP CSI-RS to be used by the WD 22 as a reference resource set. In some embodiments, a propagation delay value is a difference between propagation delays and a transmit frequency value is a difference between frequencies, associated with two NZP CSI-RS resources.

FIG. 15 is a flowchart of an example process in a wireless device 22 according to some embodiments of the present disclosure. One or more blocks described herein may be performed by one or more elements of wireless device 22 such as by one or more of processing circuitry 84 (including the reporting quantity unit 34), processor 86, radio interface 82 and/or communication interface 60. Wireless device 22 such as via processing circuitry 84 and/or processor 86 and/or radio interface 82 is configured to receive from the network node an indication of a plurality of non-zero power channel state information reference signal, NZP CSI-RS, resources (Block S138). The process also includes determining at least one of a propagation delay value and a transmit frequency value for each NZP CSI-RS resource of at least a subset of the plurality of indicated NZP CSI-RS resources, the at least one of a propagation delay value and a transmit frequency value for an NZP CSI-RS resource being based at least in part on measurements on the NZP CSI-RS resource.

In some embodiments, the plurality of NZP CSI-RS resources are grouped into NZP CSI-RS resource sets, and the indication indicates a plurality of NZP CSI-RS resource sets. In some embodiments, the indication indicates one of the indicated NZP CSI-RS resources as a reference resource. In some embodiments, the at least one of a propagation delay value and a transmit frequency value are determined relative to a reference resource. In some embodiments, the reference resource is selected as the NZP CSI-RS resource having a strongest reference signal received power of the plurality of NZP CSI-RS resources. In some embodiments, the reference resource is determined according to an implicit rule. In some embodiments, the at least one of a propagation delay value and a transmit frequency value is determined based at least in part on a reference time. In some embodiments, the indication further indicates a subset of NZP CSI-RS resources for which one of propagation delay values and transmit frequency values are to be reported. In some embodiments, a propagation delay value is a difference between propagation delays and a transmit frequency value is a difference between frequencies, associated with two NZP CSI-RS resources.

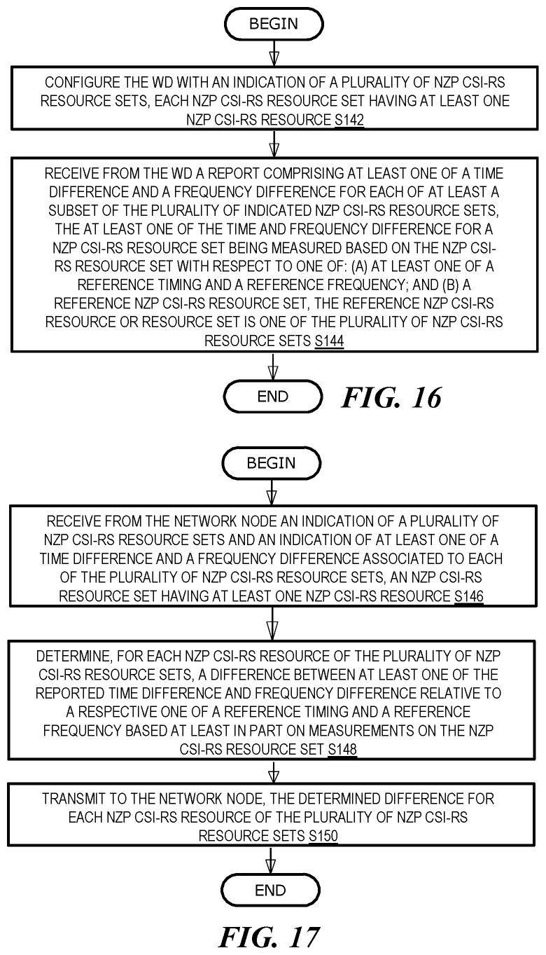

FIG. 16 is a flowchart of an example process in a network node 16 for feedback of delay and frequency differences among multiple transmission reception points (TRPs). One or more blocks described herein may be performed by one or more elements of network node 16 such as by one or more of processing circuitry 68 (including the resource indication unit 32), processor 70, radio interface 62 and/or communication interface 60. Network node 16 such as via processing circuitry 68 and/or processor 70 and/or radio interface 62 and/or communication interface 60 is configured to configure the WD 22 with an indication of a plurality of non-zero power channel state information reference signal, NZP CSI-RS, resource sets, each NZP CSI-RS resource set having at least one NZP CSI-RS resource (Block S142). The process also includes receiving from the WD 22 a report comprising at least one of a time difference and a frequency difference for each of at least a subset of the plurality of indicated NZP CSI-RS resource sets, the at least one of the time and frequency difference for a NZP CSI-RS resource set being measured based on the NZP CSI-RS resource set with respect to one of: (a) at least one of a reference timing and a reference frequency; and (b) a reference NZP CSI-RS resource set, the reference NZP CSI-RS resource or resource set is one of the plurality of NZP CSI-RS resource sets (Block S144).

In some embodiments, each NZP CSI-RS resource set of the plurality of NZP CSI-RS resource sets is a tracking reference signal, TRS, resource set, and wherein information related to a TRS is one of indicated and configured in the NZP CSI-RS resource set. In some embodiments, each NZP CSI-RS resource of the plurality of NZP CSI-RS resources is a tracking reference signal, TRS, resource. In some embodiments, the plurality of NZP CSI-RS resource sets are transmitted from respective ones of a plurality of transmission and reception points, TRPs. In some embodiments, the report further includes an indication of which one of the plurality of NZP CSI-RS resource sets is the reference NZP CSI-RS resource set, and wherein the at least one of a time and frequency difference for the reference NZP CSI-RS resource set is zero and not included in the report. In some embodiments, the reference NZP CSI-RS set is pre-specified or indicated to the WD 22. In some embodiments, the time difference for a NZP CSI-RS resource set is a difference between a time delay of a signal received on a NZP CSI-RS resource of the NZP CSI-RS set at the WD 22 and a time delay of the signal received on the reference NZP CSI-RS resource at the WD 22. In some embodiments, the frequency difference for a NZP CSI-RS resource set is a difference between a frequency of a signal received on a NZP CSI-RS resource of the NZP CSI-RS resource set at the WD 22 and a frequency of the signal received on the reference NZP CSI-RS resource at the WD 22. In some embodiments, the time difference for a NZP CSI-RS resource set is a time delay of the signal received on a NZP CSI-RS resource at the WD 22 with respect to the reference timing. In some embodiments, the frequency difference for a NZP CSI-RS resource set is a difference between a frequency of a signal received on a NZP CSI-RS resource at the WD 22 with respect to the reference frequency. In some embodiments, the report further includes an indication of a number of transmission and reception points, TRPs, each TRP being associated with at least one of a time difference and a frequency difference. In some embodiments, the network node applies at least one of a time and a frequency pre-compensation to at least one of a physical downlink channel and a reference signal at each of the plurality of transmission and reception points, TRPs, based on the received at least one of a time and frequency difference for a corresponding NZP CSI-RS resource.

FIG. 17 is a flowchart of an example process in a wireless device 22 according to some embodiments of the present disclosure. One or more blocks described herein may be performed by one or more elements of wireless device 22 such as by one or more of processing circuitry 84 (including the reporting quantity 34), processor 86, radio interface 82 and/or communication interface 60. Wireless device 22 such as via processing circuitry 84 and/or processor 86 and/or radio interface 82 is configured to receive from the network node an indication of a plurality of non-zero power channel state information reference signal, NZP CSI-RS, resource sets and an indication of at least one of a time difference and a frequency difference associated to each of the plurality of NZP CSI-RS resource sets, an NZP CSI-RS resource set having at least one NZP CSI-RS resource (Block S146). The method includes determining, for each NZP CSI-RS resource of the plurality of NZP CSI-RS resource sets, a difference between at least one of the reported time difference and frequency difference relative to a respective one of a reference timing and a reference frequency based at least in part on measurements on the NZP CSI-RS resource set (Block S148). The method also includes transmitting, to the network node, the determined difference for each NZP CSI-RS resource of the plurality of NZP CSI-RS resource sets (Block S150).

According to this aspect, in some embodiments, each of the plurality of NZP CSI-RS resource sets is a tracking reference signal, TRS, resource set. In some embodiments, the reference timing and reference frequency area downlink timing and a downlink carrier frequency, respectively, acquired by the WD 22 based on a previously received downlink reference signal. In some embodiments, the reference timing and reference frequency are a downlink timing and a downlink carrier frequency, respectively, associated to a reference NZP CSI-RS resource set, wherein the reference NZP CSI-RS resource set is one of the plurality of NZP CSI-RS resource sets. In some embodiments, the reference NZP CSI-RS resource set is indicated explicitly by the network node. In some embodiments, the reference NZP CSI-RS resource or resource set is a first NZP CSI-RS resource or resource set configured in the plurality of NZP CSI-RS resources or resource sets. In some embodiments, the reference NZP CSI-RS resource set is determined and reported by the WD 22. In some embodiments, the time difference for a NZP CSI-RS resource set is a difference between a time delay of the NZP CSI-RS resource received at the WD 22 and a time delay of the reference NZP CSI-RS resource received at the WD 22. In some embodiments, the frequency difference for a NZP CSI-RS resource set is a difference between a carrier frequency of a NZP CSI-RS resource of the NZP CSI-RS resource set received at the WD 22 and a carrier frequency of the reference NZP CSI-RS resource received at the WD 22. In some embodiments, the time difference for a NZP CSI-RS resource set is a time delay of the NZP CSI-RS resource received at the WD 22 with respect to the reference timing. In some embodiments, the frequency difference for a NZP CSI-RS resource set is a difference between a carrier frequency of a NZP CSI-RS resource received at the WD 22 with respect to the reference carrier frequency. In some embodiments, the report further comprises an indication of the reference resource set. In some embodiments, the report is one of periodic, aperiodic, and semi-persistent. In some embodiments, each of the plurality of NZP CSI-RS resource sets is one of periodic, aperiodic, and semi-persistent. In some embodiments, the indication of a plurality of non-zero power channel state information reference signal, NZP CSI-RS, resource sets, and the indication of the at least one of a time difference and a frequency difference is carried in one of a downlink control information, DCI, format, a radio resource control, RRC, message, and a medium access control, MAC, message.

Having described the general process flow of arrangements of the disclosure and having provided examples of hardware and software arrangements for implementing the processes and functions of the disclosure, the sections below provide details and examples of arrangements for feedback of delay and frequency differences among multiple transmission reception points (TRPs).

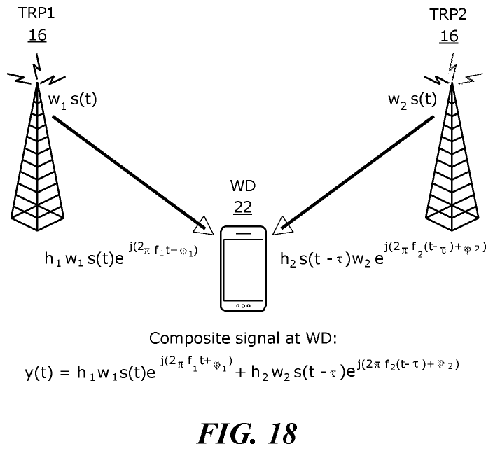

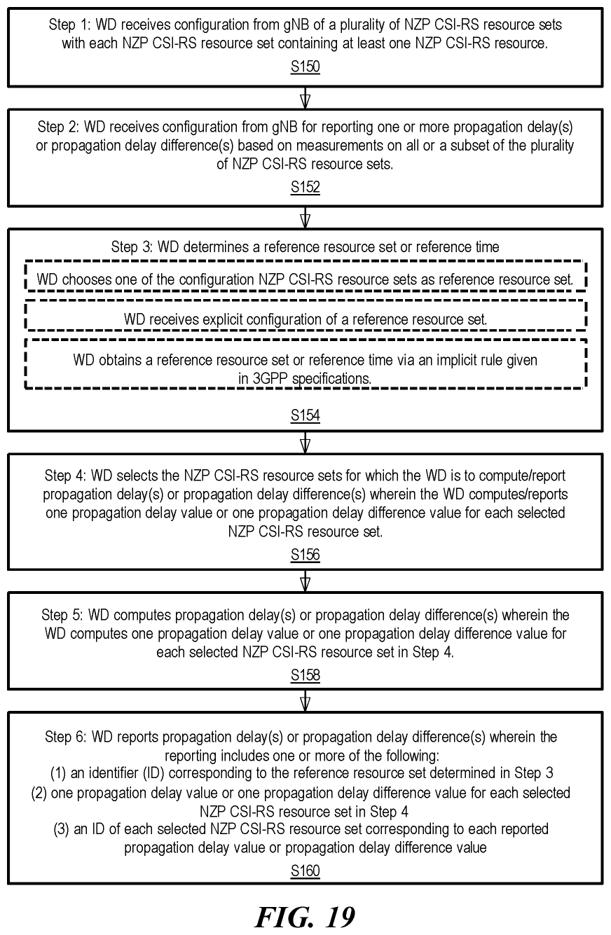

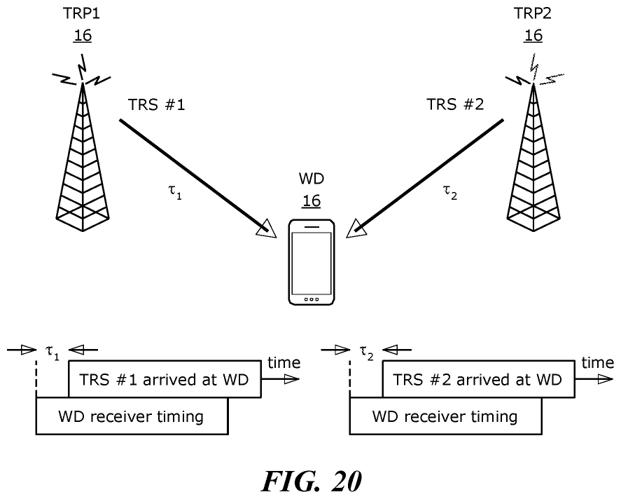

FIG. 18 shows an example of transmission of a signal s(t) from two TRPs. A first set of embodiments for propagation delay/propagation delay difference reporting are disclosed in the flow chart of FIG. 19. In this set of embodiments, each TRP corresponds to a NZP CSI-RS resource set. FIG. 20 shows a first TRS sent from TRP1 and a second TRS sent from TRP 2.

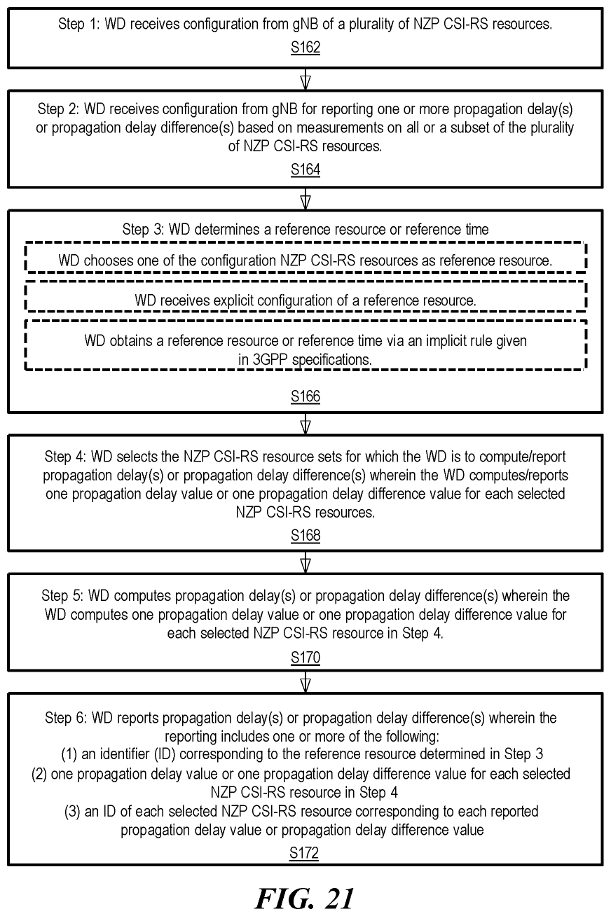

A second set of embodiments for propagation delay/propagation delay difference reporting are summarized in the flow chart of FIG. 21. In this set of embodiments, each TRP corresponds to a NZP CSI-RS resource.

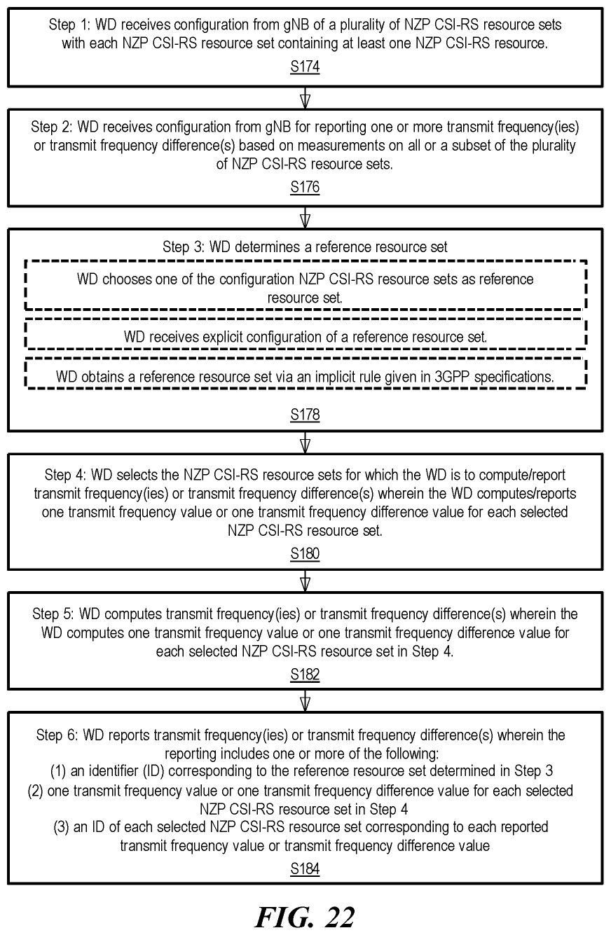

A set of embodiments for transmit frequency/transmit frequency difference reporting are summarized in the flow chart of FIG. 22. In this set of embodiments, each TRP corresponds to a NZP CSI-RS resource set.

Some embodiments include features disclosed in the flowcharts shown in FIGS. 19, 21 and 22. Particularly, in these flowcharts, how the WD 22 is configured to report propagation delay/propagation delay differences and/or transmit frequency/transmit frequency differences are disclosed. Steps may involve (1) how reference resource/reference resource set is determined, (2) how to select TRPs 16 for which the propagation delay/propagation delay differences and/or transmit frequency/transmit frequency differences will be reported, and (3) what quantities are reported.

### Coherent Joint Transmission

FIG. 18 shows an example of transmission of a signal s(t) from two TRPs. s(t) is multiplied by two co-phasing/pre-compensation coefficients w₁ and w₂ at the two TRPs before being transmitted to the WD 22. The effective propagation channels from the two TRPs to the WD 22, including transmitter and receiver circuitries and antenna patterns associated with the two TRPs, are denoted by h₁ and h₂, respectively. f₁ and f₂ are the transmit frequencies and φ₁ and φ₂ are the random initial phases at the two TRPs. τ is the propagation delay (including possible timing offsets) difference between the two TRPs.

The composite signal at the WD 22 may be expressed as

$$y ( t ) = {h}_{1} {w}_{1} s ( t ) {e}^{j ( 2 π {f}_{1} t + {φ}_{1} )} + {h}_{2} {w}_{2} s ( t - τ ) {e}^{j ( 2 π {f}_{2} ( t - τ ) + {φ}_{2} )} \qquad ( eq . 1 )$$

For narrow-band signals and when the delay T is small, the signal envelope doesn't change much, i.e., s(t−τ)≈s(t). Thus, (eq. 1) may be revised as follows:

$$y ( t ) \approx {h}_{1} {w}_{1} s ( t ) {e}^{j ( 2 π {f}_{1} t + {φ}_{1} )} + {h}_{2} {w}_{2} s ( t ) {e}^{j ( 2 π {f}_{2} ( t - τ ) + {φ}_{2} )} \qquad ( eq . 2 )$$

$$or$$

$$y ( t ) \approx ( {h}_{1} {w}_{1} {e}^{j {φ}_{1}} + {h}_{2} {w}_{2} {e}^{j ( 2 π ( {f}_{2} - {f}_{1} ) t - 2 π {f}_{2} τ + {φ}_{2} )} ) s ( t ) {e}^{j 2 π {f}_{1} t} \qquad ( eq . 3 )$$

To coherently combine the signals from the two TRPs, the following co-phasing/pre-compensation coefficients may be used:

$${w}_{1} = {e}^{- j ( ∠ {h}_{1} + {φ}_{1} )} \qquad ( eq . 4 a )$$

$${w}_{2} = {e}^{- j ( ∠ {h}_{2} + {φ}_{2} + 2 π ( {f}_{2} - {f}_{1} ) t - 2 π {f}_{2} τ )} \qquad ( eq . 4 b )$$

where ∠(x) denotes the angle of a complex variable x. The resulted composite signal, when the above co-phasing/pre-compensation coefficients in eq. 4a-4b are applied, is then:

$${y}^{*} ( t ) = ( \vert {h}_{1} \vert + \vert {h}_{2} \vert ) s ( t ) {e}^{j 2 π {f}_{1} t} \qquad ( eq . 5 )$$

Alternatively, the co-phasing/pre-compensation coefficients may be as follows:

$${w}_{1} = 1 \qquad ( eq . 6 a )$$

$${w}_{2} = {e}^{- j ( ∠ {h}_{2} + {φ}_{2} - ∠ {h}_{1} + {φ}_{1} + 2 π ( {f}_{2} - {f}_{1} ) t - 2 π {f}_{2} τ )} \qquad ( eq . 6 b )$$

The resulted composite signal, when the above co-phasing/pre-compensation coefficients in eq. 6a-6b are applied, is then:

$${y}^{*} ( t ) = ( \vert {h}_{1} \vert + \vert {h}_{2} \vert ) s ( t ) {e}^{j ( 2 π {f}_{1} t + {φ}_{1} )} \qquad ( eq . 7 )$$

Note that the only difference between eq. 5 and eq. 7 is a phase factor e^{jφ}^{₁}. The phase factor e^{j(2πf}^{₁}^{t+φ}^{₁}⁾ may be removed at WD 22 receiver and has no impact on receiver performance.

Note that the above applies also in case multiple antenna ports are deployed in each of the TRPs. In that case, additional precoding or beamforming is applied to s(t), where s(t) is data associated with a MIMO layer of PDSCH or DMRS.

For a given MIMO layer, the signal received from TRP1 would become H₁V₁w₁s(t)e^{j(2πf}^{₁}^{t+φ}^{₁}⁾, where H₁ is a N₁ by M channel matrix, V₁ is a N₁ by 1 precoding vector associated with the corresponding MIMO layer, N₁ is the number of antenna ports deployed at TRPs and M is the number of receive antennas at the WD 22. Similarly, for the given MIMO layer, the signal received from TRP2 would become H₂V₂w₂s(t)e^{j(2πf}^{₂}^{t+φ}^{₂}⁾, where H₂ is a N₂ by M channel matrix, V₂ is a N₂ by 1 precoding vector associated with the corresponding MTMO layer, N₂ is the number of antenna ports deployed at TRP2.

CJT transmission from multiple TRPs is possible for the case of multiple PDSCH layers. For R PDSCH layers, each TRP may use a corresponding N₁×R precoding matrix wherein each column in the precoding matrix corresponds to one of the R MIMO layers. In the case of R PDSCH layers, the transmitted data s(t) may consist of R different symbols (i.e., one symbol corresponding to each of the R PDSCH layers).

For CJT, it is envisioned that precoding matrices/vectors and the co-phasing/pre-compensation coefficients {w₁,w₂} may be reported by the WD 22 to the network.

### Delay and Frequency Pre-Compensation

It may be observed from eq. 4b and eq. 6b that in presence of propagation delay difference between the two TRPs, the desired co-phasing/pre-compensation coefficients are frequency dependent, i.e., different set of co-phasing/pre-compensation coefficients are needed at different frequencies. In the presence of a frequency difference between the two TRPs, the co-phasing/pre-compensation coefficients are also time dependent, i.e., different set of co-phasing/pre-compensation coefficients are needed at different time instances. Therefore, if both propagation delay and frequency are different from the two TRPs, the desired co-phasing/pre-compensation coefficients are both frequency and time dependent.

Hence, in order to derive the co-phasing/pre-compensation coefficients w₁ and w₂, one or more of the following may be reported from the WD 22 to the network:
transmit frequency associated with a TRP;
transmit frequency difference between two TRPs;
propagation delay associated with a TRP; and/or
propagation delay difference between two TRPs.

### Embodiments for Propagation Delay/Propagation Delay Difference Reporting

### First Set of Embodiments

A first set of example embodiments for computing and reporting of propagation delay(s) or propagation delay differences are shown in the flowchart of FIG. 19.

In the set of embodiments of FIG. 19, each TRP corresponds to a NZP CSI-RS resource set. The steps in the flowchart are elaborated below:
Step 1 (S150): A WD 22 receives configuration from the network node 16 of N>1 different NZP CSI-RS resource sets. Each of the NZP CSI-RS resource sets include at least one NZP CSI-RS resource:
   In one embodiment, the N different NZP CSI-RS resource sets may be configured as part of a CSI-ResourceConfig information element (IE) as defined in 3GPP TS 38.331 V 16.7.0, where a new report quantity for reporting delays or delay differences is introduced. In this embodiment, a parameter that points to the ID of the CSI-ResourceConfig information element (IE) that contains the different NZP CSI-RS resource sets is configured in a reporting configuration used for configuring propagation delay/propagation delay difference reporting;
   In another embodiment, the CSI report for the delays or delay differences is aperiodic and is triggered by a DCI format, where the N>1 different NZP CSI-RS resource sets are configured as part of CSI-AssociatedReportConfiglnfo in the CSI-AperiodicTriggerStateList IE as defined in 3GPP TS 38.331 V 16.7.0;
   In some embodiments each of the N NZP CSI-RS resource sets is configured with parameter ‘trs-Info’ set to true which means the NZP CSI-RS resources in each of the N NZP CSI-RS resource sets is a tracking reference signal (TRS). An example is shown in FIG. 20, where TRS #1 is sent from TRP1 and TRS #2 is sent from TRP 2. τ₁ and τ₂ are the time differences between the actual arrival time of TRS #1 and TRS #2, respectively, and the expected arrival time by the WD;
Step 2 (S152): The WD 22 receives configuration (e.g., via RRC configuration) from the network node 16 requesting the WD 22 to report one or more propagation delay(s) or propagation delay difference(s) based on measurements on all or a subset of the plurality of NZP CSI-RS resource sets:
   In one embodiment, a new reporting quantity may be configured as part of the CSI reporting configuration (e.g., via higher layer parameter reportQuantity as defined in 3GPP TS 38.331 V 16.7.0) in the reporting configuration used for configuring propagation delay/propagation delay difference reporting. The new reporting quantity may be set to a value of either ‘propagation delay’ or ‘propagation delay difference’ which means the WD 22 is requested to report to the value requested;
   In another embodiment, the number of propagation delay(s) or propagation delay difference(s) to be reported by the WD 22 is configured to the WD 22 by the network node 16. This number may be configured as part of the reporting configuration used for configuring propagation delay/propagation delay difference reporting;
Step 3 (S154): The WD 22 determines a reference resource set for computing and reporting propagation delay difference(s) between one or more of the multiple resource sets and the reference resource set:
   In some embodiments, the WD 22 chooses/selects one of the N different NZP CSI-RS resource sets to be used as the reference resource set. In one example, the WD 22 may choose one of the NZP CSI-RS resource sets based on the received power of the NZP CSI-RS resource(s) within the NZP CSI-RS resource sets (e.g., the NZP CSI-RS resource set which contains the NZP CSI-RS resources with the strongest Reference Signal receive power among the NZP CSI-RS resource sets). In another example, when the parameter ‘trs-info’ is set to true in the NZP CSI-RS resource sets (i.e., the NZP CSI-RS resources in the NZP CSI-RS resource sets are TRS resources), then an NZP CSI-RS resource set that the WD 22 uses for time/frequency synchronization may be selected by the WD 22 as the reference resource set. For example, in the example shown in FIG. 18, if TRS #1 is determined as the reference TRS, then the WD may report only the delay difference τ₂−τ₁ between TRS #2 and TRS #1;
   In some embodiments, the WD 22 receives explicit configuration/indication of the reference resource set. In one embodiment, an ID of the reference resource set is configured as part of the reporting configuration used for configuring propagation delay/propagation delay difference reporting. In another embodiment, a parameter indicating which NZP CSI-RS resource set is to be used as the reference resource set is configured as part of the NZP CSI-RS resource set configuration (e.g., the parameter is configured as part of NZP-CSI-RS-ResourceSet IE for example as defined in 3GPP TS 38.331 V 16.7.0 or a similar IE). In some cases, the reference resource set is one among the configured N NZP CSI-RS resource sets configured in Step 1. For example, one of the N configured NZP CSI-RS resource sets may be configured with a ‘reference resource set indication’ parameter;
   In some embodiments, the reference resource set may be given by an implicit rule specified in 3GPP specifications. In one example, the reference resource set may be given by the one NZP CSI-RS resource set that has the lower ID (e.g., lower nzp-CSI-ResourceSetId as defined in 3GPP TS 38.331 V 16.7.0) among the N configured NZP CSI-RS resource sets. Alternatively, the reference resource set may be given by the one NZP CSI-RS resource set that has the higher ID (e.g., higher nzp-CSI-ResourceSetId for example as defined in 3GPP TS 38.331 V 16.7.0) among the N configured NZP CSI-RS resource sets;
   In another example of an implicit rule, the reference resource set may be given by the first NZP CSI-RS resource set in a list of N configured NZP CSI-RS resource sets. Alternatively, the reference resource set may be given by the last NZP CSI-RS resource set in a list of N configured NZP CSI-RS resource sets;
   In another embodiment, a reference resource set is not determined and the WD reports a delay for each of the resource sets. For example, in the example shown in FIG. 20, the WD reports both τ_1 and τ_2;
Step 4 (S156): The WD 22 selects a subset of the NZP CSI-RS resource sets for which the WD 22 is to compute/report propagation delay(s) or propagation delay difference(s) wherein the WD 22 computes/reports one propagation delay value or one propagation delay difference value for each selected NZP CSI-RS resource set. Note that the NZP CSI-RS resource sets are selected from the configured N NZP CSI-RS resource sets configured in Step 1 (S150):
   In an optional embodiment, the WD 22 receives explicit configuration/indication from the network node 16 on NZP CSI-RS resource sets for which the WD 22 is to compute/report propagation delay(s) or propagation delay difference(s). The explicit configuration/indication may be received via RRC signaling, MAC CE signaling, DCI signaling, or any combination of these types of signaling;
   In the above optional embodiment, the WD 22 may select the NZP CSI-RS resource sets following the explicit configuration/indication from the network node 16. In one embodiment, IDs of the NZP CSI-RS resource sets to be selected are configured as part of the reporting configuration used for configuring propagation delay/propagation delay difference reporting. In another embodiment, a parameter indicating whether a given NZP CSI-RS resource set is to be selected is configured as part of the given NZP CSI-RS resource set configuration (e.g., the parameter is configured as part of NZP-CSI-RS-ResourceSet IE as defined in 3GPP TS 38.331 V 16.7.0 or a similar IE);
   In another embodiment, the WD 22 receives a configuration/indication of a maximum number of NZP CSI-RS resource sets to be selected by the WD 22. This configuration/indication may be received via RRC signaling, MAC CE signaling, DCI signaling, or any combination of these types of signaling;
Step 5 (S158): The WD 22 computes propagation delay(s) or propagation delay difference(s) wherein the WD 22 computes one propagation delay value or one propagation delay difference value for each selected NZP CSI-RS resource set in Step 4 (S156). For example, in the example shown in FIG. 20, the WD may report both τ₁ and τ₂, one for each of TRS #1 and TRS #2, or report only the time difference τ₂−τ₁ between TRS #2 and TRS #1, which is the reference TRS in this case: and
Step 6 (S160): The WD 22 reports propagation delay(s) or propagation delay difference(s) wherein the reporting includes one or more of the following:
   an identifier (ID) corresponding to the reference resource set determined in Step 3 (S154);
   one propagation delay value for each selected NZP CSI-RS resource sets or one propagation delay difference value between each of the selected NZP CSI-RS resource sets and the reference resource set; and/or
   an ID of each selected NZP CSI-RS resource set corresponding to each reported propagation delay value or propagation delay difference value;
   In some embodiments, there are a plurality of propagation delay values or propagation delay difference values in the same report from the WD 22 to the network node 16 (i.e., one propagation delay value or one propagation delay difference value for each selected NZP CSI-RS resource set);
   In one embodiment, each delay or delay difference is quantized with N_{d} bits, with a quantization step of ΔT=N_{c}T_{c}/2^{μ}, where

$${T}_{c} = \frac{1}{4096 * 480000} second ,$$

μ∈(0, 1, . . . , 4} is the numerology and N_{c} is an integer. For example, if N_{d}=6 bits, μ=0 and N_{c}=1024, a delay or delay difference of T_{d}=3 is reported, the delay may be calculated as τ=(T_{d}−31)ΔT=(3−31)×1024T_{c}=−14.24 us. A range of +/−16.67 us may be reported;
In one embodiment, when multiple propagation delay values or propagation delay difference values are reported, the first value is reported as an absolute value and the remaining values are reported as differential or relative to the first value. For example, if the computed propagation delay values or propagation delay difference values are denoted as v₁, v₂, . . . , v_{Ñ}, then the WD 22 reports v₁ as the absolute value. The relative values reported are v̅₂, . . . , v̅_{Ñ} where the relative value v̅ₘ=vₘ−v₁, m=2, . . . , Ñ;
In some embodiments, the ID corresponding to the reference resource set may not be reported by the WD 22, particularly when the reference resource set is configured/indicated explicitly to the WD 22 by the network node 16 or when the reference resource set is given by implicit rules specified in 3GPP specifications; and/or
In some embodiments, the ID(s) of the selected NZP CSI-RS resource sets may not be reported by the WD 22, particularly when the selected NZP CSI-RS resource sets are configured/indicated explicitly to the WD 22 by the network node 16.

### Second Set of Embodiments

A second set of example embodiments for computing and reporting of propagation delay(s) or propagation delay differences are shown in the flowchart of FIG. 21.

In the set of embodiments of FIG. 21, each TRP corresponds to a NZP CSI-RS resource wherein each NZP CSI-RS resource is configured with a different TCI state. The steps involved in the flowchart are elaborated below:
Step 1 (S160): A WD 22 receives configuration from the network node 16 of N>1 different NZP CSI-RS resources:
   In one embodiment, the N different NZP CSI-RS resources are configured in a single NZP CSI-RS resource set, where each of the NZP CSI-RS resource may be repeated at least two times in in time domain;
Step 2 (S162): The WD 22 receives configuration (e.g., via RRC configuration) from the network node 16 requesting the WD 22 to report one or more propagation delay(s) or propagation delay difference(s) based on measurements on all or a subset of the plurality of NZP CSI-RS resources:
   In one embodiment, a new reporting quantity may be configured as part of the CSI reporting configuration (e.g., via higher layer parameter reportQuantity for example as defined in 3GPP TS 38.331 V 16.7.0) in the reporting configuration used for configuring propagation delay/propagation delay difference reporting. The new reporting quantity may be set to a value of either ‘propagation delay’ or ‘propagation delay difference’ which means the WD 22 is requested to report to the value requested;
   In another embodiment, the number of propagation delay(s) or propagation delay difference(s) to be reported by the WD 22 is configured to the WD 22 by the network node 16. This number may be configured as part of the reporting configuration used for configuring propagation delay/propagation delay difference reporting;
Step 3 (S166): The WD 22 determines a reference resource to be used for computing propagation delay difference;
   In some embodiments, the WD 22 chooses/selects one of the N different NZP CSI-RS resources to be used as the reference resource. In one example, the WD 22 may choose one of the NZP CSI-RS resources based on the received power of the NZP CSI-RS resources (e.g., the NZP CSI-RS resource with the strongest Reference Signal receive power among the NZP CSI-RS resources);
   In some embodiments, the WD 22 receives explicit configuration/indication of the reference resource. In one embodiment, an ID of the reference resource is configured as part of the reporting configuration used for configuring propagation delay/propagation delay difference reporting. In another embodiment, a parameter indicating which NZP CSI-RS resource is to be used as the reference resource is configured as part of the NZP CSI-RS resource configuration (e.g., the parameter is configured as part of NZP-CSI-RS-Resource IE as defined in 3GPP TS 38.331 V 16.7.0 or a similar IE). In some cases, the reference resource is one among the configured N NZP CSI-RS resources configured in Step 1. For example, one of the N configured NZP CSI-RS resources may be configured with a ‘reference resource indication’ parameter;
   In some embodiments, the reference resource may be given by an implicit rule specified in 3GPP specifications. In one example, the reference resource may be given by the one NZP CSI-RS resource that has the lower ID (e.g., lower nzp-CSI-RS-ResourceId as defined in 3GPP TS 38.331 V 16.7.0) among the N configured NZP CSI-RS resources. Alternatively, the reference resource may be given by the one NZP CSI-RS resource that has the higher ID (e.g., higher nzp-CSI-RS-ResourceId as defined in 3GPP TS 38.331 V 16.7.0) among the N configured NZP CSI-RS resource;
   In another example of an implicit rule, the reference resource may be given by the first NZP CSI-RS resource in a configured NZP CSI-RS resource set. Alternatively, the reference resource may be given by the last NZP CSI-RS resource in a list of N configured NZP CSI-RS resources;
   In another embodiment, a reference resource is not determined and the WD reports a delay for each of the resource. For example, in the example shown in FIG. 20, the WD reports both τ₁ and τ₂;
   In another embodiment, a reference time may be implicitly defined in 3GPP specifications. For example, the expected starting symbol time of each NZP CSI-RS resource is used as the reference time for computing propagation delay/propagation delay difference;
Step 4 (S168): The WD 22 selects a subset of the NZP CSI-RS resources for which the WD 22 is to compute/report propagation delay(s) or propagation delay difference(s) wherein the WD 22 computes/reports one propagation delay value or one propagation delay difference value for each selected NZP CSI-RS resource. Note that the NZP CSI-RS resources are selected from the configured N NZP CSI-RS resources configured in Step 1:
   In an optional embodiment, the WD 22 receives explicit configuration/indication from the network node 16 on NZP CSI-RS resources for which the WD 22 is to compute/report propagation delay(s) or propagation delay difference(s). The explicit configuration/indication may be received via RRC signaling, MAC CE signaling, DCI signaling, or any combination of these types of signaling;
   In the above optional embodiment, the WD 22 selects the NZP CSI-RS resources following the explicit configuration/indication from the network node 16. In one embodiment, IDs of the NZP CSI-RS resources to be selected are configured as part of the reporting configuration used for configuring propagation delay/propagation delay difference reporting. In another embodiment, a parameter indicating whether a given NZP CSI-RS resource is to be selected is configured as part of the given NZP CSI-RS resource configuration (e.g., the parameter is configured as part of NZP-CSI-RS-Resource IE as defined in 3GPP TS 38.331 V 16.7.0 or a similar IE);
   In another embodiment, the WD 22 receives a configuration/indication of a maximum number of NZP CSI-RS resources to be selected by the WD 22. This configuration/indication may be received via RRC signaling, MAC CE signaling, DCI signaling, or any combination of these types of signaling;
Step 5 (S170): The WD 22 computes propagation delay(s) or propagation delay difference(s) wherein the WD 22 computes one propagation delay value for each selected NZP CSI-RS resource or one propagation delay difference value between each selected NZP CSI-RS resource and a reference resource:
Step 6 (S172): The WD 22 reports propagation delay(s) or propagation delay difference(s) wherein the reporting includes one or more of the following:
   an identifier (ID) corresponding to the reference resource determined in Step 3;
   one propagation delay value or one propagation delay difference value for each selected NZP CSI-RS resources in Step 4; and/or
   an ID of each selected NZP CSI-RS resource corresponding to each reported propagation delay value or propagation delay difference value;
   In some embodiments, there are a plurality of propagation delay values or propagation delay difference values in the same report from the WD 22 to the network node 16 (i.e., one propagation delay value or one propagation delay difference value for each selected NZP CSI-RS resource);
   In one embodiment, when multiple propagation delay values or propagation delay difference values are reported, the first value is reported as an absolute value and the remaining values are reported as differential or relative to the first value. For example, if the computed propagation delay values or propagation delay difference values are denoted as v₁, v₂, . . . , v_{Ñ}, then the WD 22 reports v₁ as the absolute value. The relative values reported are v̅₂, . . . , v̅_{Ñ} where the relative value v̅ₘ=vₘ−v₁, m=2, . . . , Ñ;
   In some embodiments, the ID corresponding to the reference resource may not be reported by the WD 22, particularly when the reference resource is configured/indicated explicitly to the WD 22 by the network node 16 or when the reference resource is given by implicit rules specified in 3GPP specifications; and/or
   In some embodiments, the ID(s) of the selected NZP CSI-RS resources may not be reported by the WD 22, particularly when the selected NZP CSI-RS resources are configured/indicated explicitly to the WD 22 by the network node 16.

### Embodiments for Transmit Frequency/Transmit Frequency Difference Reporting

An example set of embodiments for computing and reporting of transmit frequency(ies) or transmit frequency differences are shown in the flow chart in FIG. 22. In the set of embodiments of FIG. 22, each TRP corresponds to a NZP CSI-RS resource set. The steps 1 through 6 (S174, S176, S178, S180, S182 and S184) in FIG. 22 are similar to the steps 1 through 6 of FIG. 19, except for the following differences:
the reporting quantity in the embodiments of FIG. 22 is either transmit frequency or transmit frequency difference as opposed to propagation delay or propagation delay difference:
   The transmit frequency or transmit frequency difference may be quantized with a step size and a number of bits; and/or
the WD 22 computes/reports transmit frequency(ies) or transmit frequency differences in the embodiments of FIG. 22 as opposed to propagation delays or propagation delay differences.

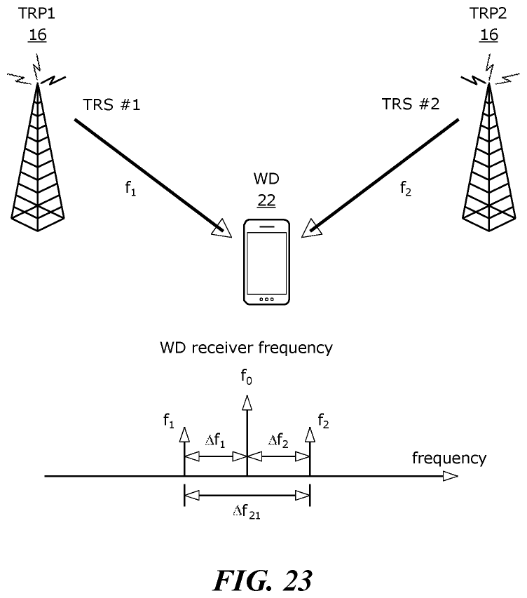

An example is shown in FIG. 23, where TRS #1 and TRS #2 are sent from TRP1 and TRP2, respectively. The WD received frequency is f₀ while the frequencies associated with TRS #1 and TRS #2 are f₁ and f₂, respectively, observed at the WD receiver. The WD may report both Δf₁=f₁−f₀ and Δf₂=f₂−f₀, or report only the frequency difference between the two TRSs, i.e., Δf₂₁=f₂−f₁, where TRS #1 is determined as the reference resource

In some embodiments, the WD 22 may be configured to compute/report both transmit frequency/transmit frequency difference and propagation delay/propagation delay difference values simultaneously. In this case, the WD 22 reports both transmit frequency/transmit frequency difference and propagation delay/propagation delay difference values by a combination of the embodiments discussed herein.

In some embodiments, the WD 22 may report transmit frequency/transmit frequency difference values and/or propagation delay/propagation delay difference values as part of a dedicated report or jointly as part of a CSI report containing other CSI parameters such as PMI, RI, CQI, RSRP, etc.

In the embodiment sets above, the NZP CSI-RS resources or resource sets may be configured in a same time slot or in different time slots and may be periodic, semi-persistent, or aperiodic. The delay/delay difference and/or frequency/frequency difference reporting may be periodic, semi-persistent, or aperiodic.

Some embodiments may include one or more of the following:

Embodiment A1. A network node configured to communicate with a wireless device, WD, the network node configured to, and/or comprising a radio interface and/or comprising processing circuitry configured to:
configure the WD with an indication of a plurality of non-zero power channel state information reference signal, NZP CSI-RS, resources; and
receive from the WD at least one of a propagation delay value and a transmit frequency value for each NZP CSI-RS resource of at least a subset of the plurality of indicated NZP CSI-RS resources, the at least one of a propagation delay value and a transmit frequency value for an NZP CSI-RS resource being based at least in part on measurements on the NZP CSI-RS resource.

Embodiment A2. The network node of Embodiment A1, wherein the plurality of NZP CSI-RS resources are grouped into NZP CSI-RS resource sets, and the indication indicates a plurality of NZP CSI-RS resource sets.

Embodiment A3. The network node of any of Embodiments A1 and A2, wherein the indication indicates a subset of NZP CSI-RS resources for which one of propagation delay values and transmit frequency values are to be reported.

Embodiment A4. The network node of any of Embodiments A1-A3, wherein the indication indicates one of the plurality of indicated NZP CSI-RS to be used by the WD as a reference resource set.

Embodiment A5. The network node of any of Embodiments A1-A4, wherein a propagation delay value is a difference between propagation delays and a transmit frequency value is a difference between frequencies, associated with two NZP CSI-RS resources.

Embodiment B1. A method implemented in a network node configured to communicate with a wireless device, WD, the method comprising:
configuring the WD with an indication of a plurality of non-zero power channel state information reference signal, NZP CSI-RS, resources; and
receiving from the WD at least one of a propagation delay value and a transmit frequency value for each NZP CSI-RS resource of at least a subset of the plurality of indicated NZP CSI-RS resources, the at least one of a propagation delay value and a transmit frequency value for an NZP CSI-RS resource being based at least in part on measurements on the NZP CSI-RS resource.

Embodiment B2. The method of Embodiment B1, wherein the plurality of NZP CSI-RS resources are grouped into NZP CSI-RS resource sets, and the indication indicates a plurality of NZP CST-RS resource sets.

Embodiment B3. The method of any of Embodiments B1 and B2, wherein the indication indicates a subset of NZP CSI-RS resources for which one of propagation delay values and transmit frequency values are to be reported.

Embodiment B4. The method of any of Embodiments B1-B3, wherein the indication indicates one of the plurality of indicated NZP CSI-RS to be used by the WD as a reference resource set.

Embodiment B5. The method of any of Embodiments B1-B4, wherein a propagation delay value is a difference between propagation delays and a transmit frequency value is a difference between frequencies, associated with two NZP CSI-RS resources.

Embodiment C1. A wireless device (WD) configured to communicate with a network node, the WD configured to, and/or comprising a radio interface and/or processing circuitry configured to:
receive from the network node an indication of a plurality of non-zero power channel state information reference signal, NZP CSI-RS, resources; and
determine at least one of a propagation delay value and a transmit frequency value for each NZP CSI-RS resource of at least a subset of the plurality of indicated NZP CSI-RS resources, the at least one of a propagation delay value and a transmit frequency value for an NZP CSI-RS resource being based at least in part on measurements on the NZP CSI-RS resource.

Embodiment C2. The WD of Embodiment C1, wherein the plurality of NZP CSI-RS resources are grouped into NZP CSI-RS resource sets, and the indication indicates a plurality of NZP CSI-RS resource sets.

Embodiment C3. The WD of any of Embodiment C1 and C2, wherein the indication indicates one of the indicated NZP CSI-RS resources as a reference resource.

Embodiment C4. The WD of any of Embodiments C1-C3, the at least one of a propagation delay value and a transmit frequency value are determined relative to a reference resource.

Embodiment C5. The WD of Embodiment C4, wherein the reference resource is selected as the NZP CSI-RS resource having a strongest reference signal received power of the plurality of NZP CSI-RS resources.

Embodiment C6. The WD of Embodiment C4, wherein the reference resource is determined according to an implicit rule.

Embodiment C7. The WD of any of Embodiments C1-C6, wherein the at least one of a propagation delay value and a transmit frequency value is determined based at least in part on a reference time.

Embodiment C8. The WD of any of Embodiments C1-C5, wherein the indication further indicates a subset of NZP CSI-RS resources for which one of propagation delay values and transmit frequency values are to be reported.

Embodiment C9. The WD of any of Embodiments C1-C6, wherein a propagation delay value is a difference between propagation delays and a transmit frequency value is a difference between frequencies, associated with two NZP CSI-RS resources.

Embodiment D1. A method implemented in a wireless device (WD) configured to communicate with a network node, the method comprising: receiving from the network node an indication of a plurality of non-zero power channel state information reference signal, NZP CSI-RS, resources; and determining at least one of a propagation delay value and a transmit frequency value for each NZP CSI-RS resource of at least a subset of the plurality of indicated NZP CSI-RS resources, the at least one of a propagation delay value and a transmit frequency value for an NZP CSI-RS resource being based at least in part on measurements on the NZP CSI-RS resource.

Embodiment D2. The method of Embodiment D1, wherein the plurality of NZP CSI-RS resources are grouped into NZP CSI-RS resource sets, and the indication indicates a plurality of NZP CSI-RS resource sets.

Embodiment D3. The method of any of Embodiment D1 and D2, wherein the indication indicates one of the indicated NZP CSI-RS resources as a reference resource.

Embodiment D4. The method of any of Embodiments D1-D3, wherein the at least one of a propagation delay value and a transmit frequency value are determined relative to a reference resource.

Embodiment D5. The method of Embodiment D4, wherein the reference resource is selected as the NZP CSI-RS resource having a strongest reference signal received power of the plurality of NZP CSI-RS resources.

Embodiment D6. The method of Embodiment D4, wherein the reference resource is determined according to an implicit rule.

Embodiment D7. The method of any of Embodiments D1-D6, wherein the at least one of a propagation delay value and a transmit frequency value is determined based at least in part on a reference time.

Embodiment D8. The method of any of Embodiments D1-D5, wherein the indication further indicates a subset of NZP CSI-RS resources for which one of propagation delay values and transmit frequency values are to be reported.

Embodiment D9. The method of any of Embodiments D1-D6, wherein a propagation delay value is a difference between propagation delays and a transmit frequency value is a difference between frequencies, associated with two NZP CSI-RS resources.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A network node (16) configured to communicate with a wireless device, WD (22), the network node (16) comprising:
processing circuitry (68) configured to configure the WD (22) with an indication of a plurality of non-zero power channel state information reference signal, NZP CSI-RS, resource sets, each NZP CSI-RS resource set having at least one NZP CSI-RS resource; and
a radio interface (72) in communication with the processing circuitry (68) and configured to receive from the WD (22) a report comprising at least one of a time difference and a frequency difference for each of at least a subset of the plurality of indicated NZP CSI-RS resource sets, the at least one of the time and frequency difference for a NZP CSI-RS resource set being measured based on the NZP CSI-RS resource set with respect to one of:
(a) at least one of a reference timing and a reference frequency; and
(b) a reference NZP CSI-RS resource set, the reference NZP CSI-RS resource or resource set is one of the plurality of NZP CSI-RS resource sets.

2. The network node (16) of claim 1, wherein each NZP CSI-RS resource set of the plurality of NZP CSI-RS resource sets is a tracking reference signal, TRS, resource set, and wherein information related to a TRS is one of indicated and configured in the NZP CSI-RS resource set.

3. The network node (16) of claim 1, wherein each NZP CSI-RS resource of the plurality of NZP CSI-RS resources is a tracking reference signal, TRS, resource.

4. The network node (16) of any of claims 1-3, wherein the plurality of NZP CSI-RS resource sets are transmitted from respective ones of a plurality of transmission and reception points, TRPs.

5. The network node (16) of any of claims 1-4, wherein the report further includes an indication of which one of the plurality of NZP CSI-RS resource sets is the reference NZP CST-RS resource set, and wherein the at least one of a time and frequency difference for the reference NZP CSI-RS resource set is zero and not included in the report.

6. The network node (16) of any of claims 1-5, wherein the reference NZP CSI-RS set is pre-specified or indicated to the WD.

7. The network node (16) of any of claims 1-6, wherein the time difference for a NZP CSI-RS resource set is a difference between a time delay of a signal received on a NZP CSI-RS resource of the NZP CSI-RS set at the WD and a time delay of the signal received on the reference NZP CSI-RS resource at the WD.

8. The network node (16) of any of claims 1-6, wherein the frequency difference for a NZP CSI-RS resource set is a difference between a frequency of a signal received on a NZP CSI-RS resource of the NZP CSI-RS resource set at the WD and a frequency of the signal received on the reference NZP CSI-RS resource at the WD.

9. The network node (16) of any of claims 1-6, wherein the time difference for a NZP CSI-RS resource set is a time delay of the signal received on a NZP CSI-RS resource at the WD with respect to the reference timing.

10. The network node (16) of any of claims 1-6, wherein the frequency difference for a NZP CSI-RS resource set is a difference between a frequency of a signal received on a NZP CSI-RS resource at the WD with respect to the reference frequency.

11. The network node (16) of any of claims 1-10, wherein the report further includes an indication of a number of transmission and reception points, TRPs, each TRP being associated with at least one of a time difference and a frequency difference.

12. The network node (16) of any of claims 1-11, wherein the network node applies at least one of a time and a frequency pre-compensation to at least one of a physical downlink channel and a reference signal at each of the plurality of transmission and reception points, TRPs, based on the received at least one of a time and frequency difference for a corresponding NZP CSI-RS resource.

13. A method in a network node (16) configured to communicate with a wireless device, WD (22), the method comprising:
configuring (S142) the WD (22) with an indication of a plurality of non-zero power channel state information reference signal, NZP CSI-RS, resource sets, each NZP CSI-RS resource set having at least one NZP CSI-RS resource; and
receiving (S144) from the WD (22) a report comprising at least one of a time difference and a frequency difference for each of at least a subset of the plurality of indicated NZP CSI-RS resource sets, the at least one of the time and frequency difference for a NZP CSI-RS resource set being measured based on the NZP CSI-RS resource set with respect to one of:
(a) at least one of a reference timing and a reference frequency; and
(b) a reference NZP CSI-RS resource set, the reference NZP CSI-RS resource or resource set is one of the plurality of NZP CSI-RS resource sets.

14. The method of claim 13, wherein each NZP CSI-RS resource set of the plurality of NZP CSI-RS resource sets is a tracking reference signal, TRS, resource set, and wherein information related to a TRS is one of indicated and configured in the NZP CSI-RS resource set.

15. The method of claim 13, wherein each NZP CSI-RS resource of the plurality of NZP CSI-RS resources is a tracking reference signal, TRS, resource.

16. The method of any of claims 13-15, wherein the plurality of NZP CSI-RS resource sets are transmitted from respective ones of a plurality of transmission and reception points, TRPs.

17. The method of any of claims 13-16, wherein the report further includes an indication of which one of the plurality of NZP CSI-RS resource sets is the reference NZP CSI-RS resource set, and wherein the at least one of a time and frequency difference for the reference NZP CSI-RS resource set is zero and not included in the report.

18. The method of any of claims 13-17, wherein the reference NZP CSI-RS set is pre-specified or indicated to the WD.

19. The method of any of claims 13-18, wherein the time difference for a NZP CSI-RS resource set is a difference between a time delay of a signal received on a NZP CSI-RS resource of the NZP CSI-RS set at the WD and a time delay of the signal received on the reference NZP CSI-RS resource at the WD.

20. The method of any of claims 13-18, wherein the frequency difference for a NZP CSI-RS resource set is a difference between a frequency of a signal received on a NZP CSI-RS resource of the NZP CSI-RS resource set at the WD and a frequency of the signal received on the reference NZP CSI-RS resource at the WD.

21. The method of any of claims 13-18, wherein the time difference for a NZP CSI-RS resource set is a time delay of the signal received on a NZP CSI-RS resource at the WD with respect to the reference timing.

22. The method of any of claims 13-18, wherein the frequency difference for a NZP CSI-RS resource set is a difference between a frequency of a signal received on a NZP CSI-RS resource at the WD with respect to the reference frequency.

23. The method of any of claims 13-22, wherein the report further includes an indication of a number of transmission and reception points, TRPs, each TRP being associated with at least one of a time difference and a frequency difference.

24. The method of any of claims 13-23, wherein the network node applies at least one of a time and a frequency pre-compensation to at least one of a physical downlink channel and a reference signal at each of the plurality of transmission and reception points, TRPs, based on the received at least one of a time and frequency difference for a corresponding NZP CST-RS resource.

25. A method in a wireless device, WD (22), configured to communicate with a network node (16), the method comprising:
receiving (S146) from the network node (16) an indication of a plurality of non-zero power channel state information reference signal, NZP CSI-RS, resource sets and an indication of at least one of a time difference and a frequency difference associated to each of the plurality of NZP CSI-RS resource sets, an NZP CSI-RS resource set having at least one NZP CSI-RS resource; and
determining (S148), for each NZP CSI-RS resource of the plurality of NZP CSI-RS resource sets, a difference between at least one of the reported time difference and frequency difference relative to a respective one of a reference timing and a reference frequency based at least in part on measurements on the NZP CSI-RS resource set; and
transmitting (S150), to the network node, the determined difference for each NZP CSI-RS resource of the plurality of NZP CSI-RS resource sets.

26. The method of claim 25, wherein each of the plurality of NZP CSI-RS resource sets is a tracking reference signal, TRS, resource set.

27. The method of any of claims 25 and 26, wherein the reference timing and reference frequency area downlink timing and a downlink carrier frequency, respectively, acquired by the WD based on a previously received downlink reference signal.

28. The method of any of claims 25 and 26, wherein the reference timing and reference frequency are a downlink timing and a downlink carrier frequency, respectively, associated to a reference NZP CSI-RS resource set, wherein the reference NZP CSI-RS resource set is one of the plurality of NZP CSI-RS resource sets.

29. The method of any of claims 25-28, wherein the reference NZP CSI-RS resource set is indicated explicitly by the network node.

30. The method of any of claims 25-28, wherein the reference NZP CSI-RS resource or resource set is a first NZP CSI-RS resource or resource set configured in the plurality of NZP CSI-RS resources or resource sets.

31. The method of any of claims 25-28, wherein the reference NZP CSI-RS resource set is determined and reported by the WD.

32. The method of any of claims 25-31, wherein the time difference for a NZP CSI-RS resource set is a difference between a time delay of the NZP CSI-RS resource received at the WD and a time delay of the reference NZP CSI-RS resource received at the WD.

33. The method of any of claims 25-31, wherein the frequency difference for a NZP CSI-RS resource set is a difference between a carrier frequency of a NZP CSI-RS resource of the NZP CSI-RS resource set received at the WD and a carrier frequency of the reference NZP CSI-RS resource received at the WD.

34. The method of any of claims 25-31, wherein the time difference for a NZP CSI-RS resource set is a time delay of the NZP CSI-RS resource received at the WD with respect to the reference timing.

35. The method of any of claims 25-31, wherein the frequency difference for a NZP CSI-RS resource set is a difference between a carrier frequency of a NZP CSI-RS resource received at the WD with respect to the reference carrier frequency.

36. The method of any of claims 25-35, wherein the report further comprises an indication of the reference resource set.

37. The method of any of claims 25-36, wherein the report is one of periodic, aperiodic, and semi-persistent.

38. The method of any of claims 25-37, wherein each of the plurality of NZP CST-RS resource sets is one of periodic, aperiodic, and semi-persistent.

39. The method of any of claims 25-38, wherein the indication of a plurality of non-zero power channel state information reference signal, NZP CSI-RS, resource sets, and the indication of the at least one of a time difference and a frequency difference is carried in one of a downlink control information, DCI, format, a radio resource control, RRC, message, and a medium access control, MAC, message.

40. A wireless device, WD (22), configured to communicate with a network node (16), the WD (22) comprising:
a radio interface configured to receive (S146) from the network node (16) an indication of a plurality of non-zero power channel state information reference signal, NZP CSI-RS, resource sets and an indication of at least one of a time difference and a frequency difference associated to each of the plurality of NZP CSI-RS resource sets, an NZP CSI-RS resource set having at least one NZP CSI-RS resource; and
processing circuitry in communication with the radio interface and configured to determine (S148), for each NZP CSI-RS resource of the plurality of NZP CSI-RS resource sets, a difference between at least one of the reported time difference and frequency difference relative to a respective one of a reference timing and a reference frequency based at least in part on measurements on the NZP CSI-RS resource set; and
the radio interface being further configured to transmit, to the network node, the determined difference for each NZP CSI-RS resource of the plurality of NZP CSI-RS resource sets.

41. The WD (22) of claim 40, wherein each of the plurality of NZP CSI-RS resource sets is a tracking reference signal, TRS, resource set.

42. The WD (22) of any of claims 40 and 41, wherein the reference timing and reference frequency area downlink timing and a downlink carrier frequency, respectively, acquired by the WD based on a previously received downlink reference signal.

43. The WD (22) of any of claims 40 and 41, wherein the reference timing and reference frequency are a downlink timing and a downlink carrier frequency, respectively, associated to a reference NZP CSI-RS resource set, wherein the reference NZP CSI-RS resource set is one of the plurality of NZP CSI-RS resource sets.

44. The WD (22) of any of claims 40-43, wherein the reference NZP CSI-RS resource set is indicated explicitly by the network node.

45. The WD (22) of any of claims 40-43, wherein the reference NZP CSI-RS resource or resource set is a first NZP CSI-RS resource or resource set configured in the plurality of NZP CSI-RS resources or resource sets.

46. The WD (22) of any of claims 40-43, wherein the reference NZP CSI-RS resource set is determined and reported by the WD.

47. The WD (22) of any of claims 40-46, wherein the time difference for a NZP CSI-RS resource set is a difference between a time delay of the NZP CSI-RS resource received at the WD and a time delay of the reference NZP CSI-RS resource received at the WD.

48. The WD (22) of any of claims 40-46, wherein the frequency difference for a NZP CSI-RS resource set is a difference between a carrier frequency of a NZP CSI-RS resource of the NZP CSI-RS resource set received at the WD and a carrier frequency of the reference NZP CSI-RS resource received at the WD.

49. The WD (22) of any of claims 40-46, wherein the time difference for a NZP CSI-RS resource set is a time delay of the NZP CSI-RS resource received at the WD with respect to the reference timing.

50. The WD (22) of any of claims 40-46, wherein the frequency difference for a NZP CSI-RS resource set is a difference between a carrier frequency of a NZP CSI-RS resource received at the WD with respect to the reference carrier frequency.

51. The WD (22) of any of claims 40-50, wherein the report further comprises an indication of the reference resource set.

52. The WD (22) of any of claims 40-51, wherein the report is one of periodic, aperiodic, and semi-persistent.

53. The WD (22) of any of claims 40-52, wherein each of the plurality of NZP CSI-RS resource sets is one of periodic, aperiodic, and semi-persistent.

54. The WD (22) of any of claims 40-53, wherein the indication of a plurality of non-zero power channel state information reference signal, NZP CSI-RS, resource sets, and the indication of the at least one of a time difference and a frequency difference is carried in one of a downlink control information, DCI, format, a radio resource control, RRC, message, and a medium access control, MAC, message.
